(19) United States
(12) Patent Application Publication
(10) Pub. No.: US 2026/0243588 A1
(43) Pub. Date: Aug. 20, 2026

(54) EVALUATION AND PROTECTION EQUIPMENT FOR ELECTRICAL GRIDS AND METHOD

(71) Applicant: Gridguard AS, Kongsvinger (NO)

(72) Inventors: Stig Skjelvik, Skarnes (NO); Crishan Böhner, Schwäbisch Gmünd (DE)

(21) Appl. No.: 19/161,674

(22) PCT Filed: Mar. 3, 2024
(86) PCT No.: PCT/EP2024/055516

§ 371 Date: Sep. 2, 2025

(30) Foreign Application Priority Data
Mar. 3, 2023 (NO) 20230221
Apr. 21, 2023 (DE) 10 2023 110 172.2
Oct. 5, 2023 (DE) 10 2023 127 203.9

(51) Int. Cl. G01D 18/00; A01M 29/16

(52) U.S. Cl. CPC G01D 18/00; A01M 29/16

(57) ABSTRACT

The disclosure concerns a test and protection device, with several elements to detect certain events on a power grid and overhead power line as well as on a pole or in its vicinity, the pole being part of a power grid. The events are detected using an antenna measuring the radiation emitted by the overhead line as well as one or more acoustic sensors and transducers. A communication interface is provided to transmit the results to an external station for further evaluation and corresponding measures.

The present application claims priority of NO patent application NO 20230221 dated Mar. 3, 2023, the disclosure of which is incorporated herein by reference in its entirety. The present application also claims priority of DE patent application 10 2023 110 172.2 dated Apr. 21, 2023, the disclosure of which is incorporated herein by reference in its entirety. The present application finally claims priority of DE patent application 10 2023 127 203.9 dated May 10, 2023, the disclosure of which is incorporated herein by reference in its entirety

Some aspects of the proposed principle are related to an evaluation and protection device and method for acoustic deterrent targeting individual species of woodpeckers. Some further aspects concern a test and protection equipment for evaluating the quality of a wood piece, in particularly a pole. The present application also concerns an evaluation system with the test and protection equipment and a method for evaluating the quality of a wood piece and more particularly to detect the position and size of a degradation of quality in a wood piece. Some further aspects concern a testing device for contactless detection of events on a power line, in particular an overhead power line. The present application also concerns an evaluation system with one or more of the testing devices and a method for contactless detection of events on a power line, in particular an overhead power line.

Finally, some aspects concern a combined evaluation and protection device and equipment for electrical grids as well as several methods thereof.

### BACKGROUND

Electrical power grids usually include one or more power cables that are attached to poles and other structures for landlines. These structures are not only exposed to wind and weather, but may also be infested by various animals, fungus or rot.

Woodpeckers for example can cause significant damage to buildings and other structures, as well as generate noise which can be disruptive to humans. Woodpeckers use their beaks to peck at surfaces creating holes used for nest-building, food-storage, “tools” to hold pinecones as well as finding food present inside. This behavior is defined as “work pecking” and differs from the pecking defined as “drumming” who is a way of signaling to other birds.

The “drumming” is characterized by a series of pecks that is used to signalize its appearance with a unique acoustic signature for each species of woodpecker. This pecking does in general not harm the material due to the rapid speed and less force involved. The “work Pecking” is characterized by the activity when the woodpecker uses its beak with a stronger force to make holes in the material, and so creates damages.

Accordingly, the pecking made by a woodpecker represents different activities that is essential to know before considering the deterring of the woodpecker. Over the years, a number of electronic solutions have been presented to detect the presence of woodpeckers with the aim of deterring them. A common drawback with the systems is that they do not differ between its simple appearance and/or the eventual types of pecking activity that is taking place.

Further, the prior art systems fail to provide an identification of the exact woodpecker species involved and is thus not able to respond appropriately or designed relevant to the natural behavior of the relevant woodpecker species. The prior art system uses different synthetic sounds, like ultrasound, or light flashes intended to deter all woodpecker species, or birds in general. Further, such synthetic scares are known to be subject of adaptation from the birds/woodpeckers and this will potentially make the deterrent less effective over time. Another concern is that this deterrent strategy in general is intended to deter all woodpeckers from the vicinity regardless of damage/noise potential, and may as well disturb other birds and humans in the process that may have a negative effect on nature conservation. Accordingly, the prior art solutions will negatively affect the environment of all humans and animals in vicinity of the system.

Further, a lack of targeted deterrent strategy may also lead to the use of more energy in an electronic system making the solution less efficient and useful in remote locations. From CN103385237A is known an ultrasonic bird repeller. The ultrasonic bird repeller comprises a bird repeller and a housing, and an accumulator, a driving circuit, an ultrasonic generator, a light emitting flash device, a control unit and an induction device are arranged in the bird repeller housing. The ultrasonic bird repeller is designed to repell birds by using ultrasonic wave and red flash. From prior art one may also refer to US20050049877A1 is described a method and apparatus for automatically identifying animal species from their vocalizations. However, the solution will not be suitable for use on a pecking woodpecker.

Another issue with structures holding overland lines are related to changes in wooden materials, such as cracks, wood-rot or other defects appearing over time can have significant impacts on the performance and safety of a wide range of structures. For example, structural changes in wood used in bridges, buildings, utility poles and other infrastructure can compromise the structural integrity and pose a risk to public safety and operations. Detecting structural changes in a timely and accurate manner is therefore useful for ensuring the safety and performance of these structures. Current methods for detecting structural changes often rely on manual inspections using handheld apparatus or periodic testing, which can be time-consuming and costly.

For example, a common method is measuring the force needed to drill into it, and output this as a graph representing the material strength along the drilled intersection. To map the entire objects or a larger area of interest this manual process has to be repeated in different locations and or in different angles. However, such approach damages the wooden material as such and should therefore be avoided. Another approach is an acoustic measurement that measures the speed of sound from a hammer strike onto a spike in the material. The exact time point of the strike is measured by an embedded sensor in the spike, and this is transmitted via a wire or radio and can compared to the measurement of another sensor placed at the other end of the object so that the speed of the shockwave traveling through the material can be calculated. This method is then able to measure the density of the material and so classify its strength in general, but eventual pockets of damage are not mapped or identified correctly. The documents U.S. Pat. Nos. 6,871,545 and U.S. Pat. No. 7,418,866 as well as EP0379622 make use of such approaches. Yet another approach uses ultrasound emitted from a transducer in a spike inserted at one end of a utility pole when it is laying down where the sound-wave is received by a sensor in another spike at the other end. The link https://cbs-cbt.com/en/technology/syl-vatest-5-112-5 illustrates such product. Finally, it has been proposed to use penetrating radar or ultrasound echo to scan the wooden material from a device and subsequently create three dimensional images of the area measured directly near the device. To be able to scan the entire object for mapping eventual damages, the measuring device or object needs to be moved accordingly.

Apart from the above overhead power lines are installed not only in rural areas, but often span large distances through mainly isolated locations and exposed to relatively hard weather conditions. Vegetation is usually not cut, and access to the overhead power lines may become cumbersome. As a result, maintenance and overlooking such power lines requires a lot of manpower and is a time-consuming process. Consequently, companies have implemented real-time monitoring, in which possible faults, like shorts and the like, interrupting the power line can be detected. However, locating the actual fault might be difficult. Hence, remotely locating faults on overhead power lines in real-time does not only save utility companies substantial time previously used to locate faults but also offers enormous cost savings and reduces downtime for end users. Furthermore, being able to identify the type and magnitude of faults facilitates the arrangement of logistics for repairs, enhancing efficiency.

In summary, the above-mentioned issues are multilayered and require a significant effort to detect the various and identify the issues. Detecting structural electrical and environmental changes in a timely and accurate manner is therefore expedient for ensuring the safety and performance of electrical grid structured including poles and the overhead powerlines. As of now, the different issues still require manual inspection to identify the various issues and also significant logistics to be transported to the fault site to be able to address the issue.

It is therefore an object of the proposed principle to provide an evaluation and protection equipment that overcome at least some of the drawbacks mentioned herein. Those include not only the mechanical and electrical issues mentioned above but can also act as an acoustic deterrent targeting individual species of woodpeckers enabling an automated deterrent, or a deterrent strategy based on classifying the type of woodpecker species and woodpecker activity detected.

There is further a need for an evaluation and protection device and method able to improve, by the use of machine learning, determination of the issue affecting the electrical grid, inlcuding but not limited to species of woodpeckers and its activity type as well as rot or infestation of the poles as well as electrical characteristics of the overhead lines related but not limited to electrical load of the line.

A further object of the proposed principle is to provide an evaluation and protection device and method for acoustic deterrent targeting individual species of woodpeckers actively preventing damage and or noise from woodpeckers to avoid costs and nuisance for people that is efficient over long term. Likewise there is an object to provide an evaluation and protection device and method for identiyfing possible hazards or potential danger to pole or other structure of the powerline grid and thus enabling various predicitve maintaincenca options.

### SUMMARY OF THE INVENTION

This and other objects are addressed by the subject matter of the independent claims. Features and further aspects of the proposed principles are outlined in the dependent claims.

The inventor proposes an evaluation and protection device that either as a stand-alone device, but also combines various solutions to the above-mentioned issues. The evaluation and protection device can be attached stationary to a pole of an electrical power grid or arranged close by and is self-powered, using for example a battery or a rechargeable battery. Installation is easy and does not interrupt the power through the line, as the proposed evaluation and protection device is not in contact with any of the lines.

In the following, various aspects and functionalities, namely detection and deterrent of woodpeckers on a pole, detection and identification on any hazard affecting a wooden pole and characterisation of electrical parameters of the power grid are explained herein in greater detail. These aspects can be combined together, and certain elements shared to provide the respective functionalities. Particularly, the inventor proposes an evaluation and protection device that provides all of the above-mentioned functionalities attachable to a pole of a power grid and preferable self-sustainable for a long time period.

An evaluation and protection device for at least one of
acoustic deterrent targeting individual species of woodpeckers according to the proposed principle
evaluating the quality of a wood piece, in particularly a pole according to the present invention; and
contactless detection of events on a power line, in particular an overhead power line according to the present invention is defined by the technical features of some of the independent claims. Further features of the evaluation and protection device are described in the evaluation and protection device dependent claims.

A method for at least one of
acoustic deterrent targeting individual species of woodpeckers according to the present invention;
evaluating the quality of an elongated wood piece, in particularly a pole according to some aspects of the proposed principle; and
identifying one or more events affecting a power line in a remote environment according to some aspects of the proposed principle is defined by the technical features of some of the independent claims Further features of the method are described in the method dependent claims.

Some aspects of the proposed principle are related to an evaluation and protection device and method for acoustic deterrent targeting individual species of woodpeckers. The evaluation and protection device and method according to some aspects of the proposed principle is arranged to or in the vicinity of a structure or associated parts that is to be monitored. Examples of structures are buildings, chimneys, poles, etc. In accordance with the proposed principle, the evaluation and protection device and method make use of at least one acoustic sensor array to register acoustic signal data associated with the structure or associated parts being monitored. According to some aspects of the proposed principle, the registered acoustic signal data are processed and compared with patterns or signatures unique for species of woodpeckers to determine the woodpecker species involved.

Some aspects of the proposed principle further comprise comparing the registered signal data with patterns or signatures unique for types of activity to determine the activity type of the involved woodpecker. Based on the determined woodpecker species and activity type, a suitable and tailored deterrent action is chosen, adapted the woodpecker species in question.

In accordance with a further embodiment of some aspects of the proposed principle it comprises using machine learning to develop and improve the criteria of the determination of the woodpecker species or activity type and/or deterrent action. In accordance with a further embodiment of some aspects of the proposed principle it also includes using machine learning to measure the effect of the deterrent action.

By some aspects of the proposed principle is accordingly provided an evaluation and protection device and method for acoustic deterrent targeting individual species of woodpeckers capable of real-time or near real-time monitoring and deterrent of woodpecker damage and noise. By the evaluation and protection device and method according to some aspects of the proposed principle it is possible to distinguish between different activity types of the woodpecker species, and thus respond accordingly. The evaluation and protection device and method according to some aspects of the proposed principle enables the use of tailored responses using natural sounds that is known to deter the specific species of woodpeckers from specific activities. By some aspects of the proposed principle it is enabled an automatic and remote solution requiring minimum of installation effort and maintenance.

Due to the possible to tailor the deterrent action, the evaluation and protection device and method for acoustic deterrent targeting individual species of woodpeckers will provide a solution that does not un-intentionally disrupt other parts or animals of the ecosystem or is a nuisance for people and wildlife. Some aspects of the proposed principle provide a solution that is self-improving by measuring the results of the classifications model accuracy and the response from the deterrent strategy used.

It has been found by the inventor that wood pieces may carry sound differently in regard to its internal structure and composition. More particularly, sound in a wood piece propagate with different speeds differently along the wooden fibers and perpendicular to the fibers. Furthermore, the speed of sound or vibrations within the wooden material is based on the wood type, i.e., the annual wood rings, but not so much of its density. The speed of sound in a wooden material ranges between 3500 m/s to about 5000 m/s, so it is approximately 10 to 15 times faster than the speed of sound in air.

When the sound wave propagating trough the wooden material hits an area with different characteristics, like for instance a tight knot (e.g. a former branch knot), propagation changes. Likewise, damages at certain locations as well as degradation, i.e., caused by mold growth within the wooden material, vermin or bacteria induced decay change the acoustic behavior characteristics and propagation of sound waves. For instances, sound waves propagating through the wood are reflected differently at damages or rotten parts of a wood piece than on an intact portion of the material. In a similar manner, the inventor proposes to initiate vibration within a wood piece, which usually resonates in a certain manner. Such resonance changes under degradation, where the change reflects the strength as well as the position of the degradation in the wood piece.

For the purpose of the present application, the expression “resonance” shall include any response of a wood piece when being excited by a vibration. Said vibration can include a mechanical or an acoustic excitation. Consequently, the inventor utilizes those characteristics to not only detect possible degradation in a wood piece, but also identify the location and possible size of the degradation using sound wavs through the wood pieces to be tested and evaluated. The expression degradation in this regard shall represent any deviation from the norm, which includes any damage to the wood piece. Such degradation may include, but are not limited to physical damages, like ruptures or cracks, cuts, notches, or indentations, but also damages like rot, fungal infestation on the wood and the like.

Moreover, the inventor developed and trained a deep learning network that enables a user to detect degradation of parts that are not visible from the outside. It has been found that various types of degradation generate different reflective, absorbing, diffractive or transmissive behaviour. The deep learning network has been trained on such parameters enabling the network to identify correlations between those parameters and the position, size or strength of a possible degradation.

In other words, vibrations excited in the wood piece change in response to variations in the wood piece caused by degradation and/or damages in a characteristic and detectable manner. The deep learning model is trained on a variety of such changes, allowing it to obtain correlations in the vibration changes and/or acoustic wave changes through the wooden material and the location and strength of such changes. Some aspects, even allow to provide a probability evaluation of various types of degradations that may be relevant for a specific measurement.

As such degradation in wooden structures is usually increasing over a longer period and strongly influenced by environmental parameters, the inventor proposes a test and protection equipment that can either be used manually, that is installed and de-installed after measurement, but can also be installed on the wooden structure to remain there for a longer period of time.

All these aspects can be realized by a relatively small energy efficient electronic system in accordance with the proposed principle that is placed at a permanent position on a wooden object. Said electronic system is typically part of a larger number of assets in a wide geo-graphic area that can operate remotely and automatic by reporting the wooden objects structural integrity and its development over time. Such system is able to replace today's manual methods to provide timidly alerts ensuring the safety and performance and to create predictive models as an asset management system over time.

In some aspects, the inventor proposes a test and protection equipment for evaluating the quality of a wood piece. The wood piece may include, but is not limited to a flat panel, a round panel, a pole and even more generally a more complex wooden structure. The wood piece may be an elongated wood piece wherein its length is larger than its width or height. Generally, the proposed test and protection equipment is suitable for all kinds wooden workpieces and particularly pieces that are already processed, that is pieces implemented in more complex structures.

The test and protection equipment comprises a casing having a sensor surface, said sensor surface configured to be attached to a wood piece, particularly an elongated wood piece on the elongated side thereof. The casing is a box that can be tightened to the wood piece, using for example screws, flaps, and the like. In any case and after attachment of the casing to the wood piece, the sensor surface is in direct contact with the wood piece. In some aspects, the sensor surface is simply pressed onto the wood piece. In other aspects, the sensor surface is rigidly fixed to the wood piece.

The test and protection equipment in accordance with the proposed principle further comprises an acoustic transducer that is arranged in the casing. The acoustic transducer is configured to generate one or more audible sound waves and induce said sound waves into the wood piece. For such purpose, the acoustic transducer is in operative connection with the sensor surface to induce a generated audible sound wave into the wood piece attached thereto. In other words, the acoustic transducer is configured to induce vibrations into the wood piece that propagate from a starting point into all directions within the wood piece.

In this regard it is possible that the acoustic transducer does not only provide audible sound wave into the wood piece but also into the environment. By doing so the proposed equipment can be configured to produce sound similar to the woodpecker's sound as proposed above. Consequently, the inventor proposes to combine both ideas and create a test and protection equipment that has one or more transducers configured to induce said sound waves into the wood piece and sounds into the environment to deter woodpeckers as proposed herein.

Furthermore, the test and protection equipment comprises an acoustic receiver, which us also arranged in the casing. Similar to the acoustic transducer, the acoustic receiver is in operative connection with the sensor surface. The acoustic receiver is configured to detect sound signals, wherein the sound signals comprise portions of the induced sound waves reflected at interfaces of the wood piece. In some aspects, the acoustic receiver is configured to detect vibrations of or within the wood piece.

Finally, the test and protection equipment according to the proposed principle comprises a communication interface arranged in the casing and connected to the acoustic receiver. The communication interface is configured to transmit values associated with the sound signals detected by the acoustic receiver to a test and protection equipment located outside the casing. For the purpose of this application, the values and the a “sound signal transmitted by the communication interface” are used synonymously. It is understood that not the actual detected sound signal is transmitted, but a processed representation thereof.

The test and protection equipment presented herein is capable of inducing a three-dimensional sound waves into the wood piece and subsequently detect the reflected portions in three dimensions as well. This multidimensional measurement enables locating the size of a possible degradation of the wooden material at any location of the wood piece. The transducer and the receiver are positioned in the same casing close to each other and more particularly connected to the same surface, which enable a small and compact box. Consequently, the test and protection equipment is not only portable, but can actually adjoined to the wood piece to be evaluated and measured. Hence, the test and protection equipment can be easily installed and de-installed allowing quick measurements for a plurality of wood pieces.

Some aspects concern the form and structure of the sensor surface. To ensure a good transfer of sound waves into the wood piece, a tight and proper attachment between the sensor surface and the wood piece is to be established. in some aspects, the sensor surface therefore comprises a curvature configured to cling to the wood piece. Hence, the shape of the sensor surface, may not be flat, but curved to follow a respective curved from of the wooden material. In some aspects, the shape can be adjusted to provide a higher flexibility for different shapes and curvatures of the wood piece.

In some aspects, the sensor surface may comprise a flexible material, like for instance a soft plastic or a rubber material. The material should be-in some instances-dense or have good sound propagating characteristics. This will ensure that vibrations from the transducer are propagating through the material of the sensor surface into the wood piece and vice versa. In some aspects, the material of the sensor surface is different of a material of the casing not being part of the sensor surface.

In some other aspects, the acoustic transducer comprises a son or vibration emission surface, namely the surface that is excited by the transducer. Said emission surface may form a portion or a part of the sensor surface as such. Hence, the emission surface is embedded within the sensor surface. Alternatively, the emission surface may be directly attached to the sensor surface. For example, the emission surface can be directly attached to the material forming the emission surface, but on the side not attached to the wood piece. Likewise, the acoustic receiver may comprise a detector surface in some instances. Said detector surface may form a portion or a part of the sensor surface and can be embedded within the sensor surface. Similar to the emission surface, the detector surface can also be directly attached to the material forming the emission surface, but on the side not attached to the wood piece.

The distance between the emission surface and the detection surface can be smaller or in the range of than the wavelength of the respective sound waves or vibrations generated by the transducer. In some examples, the distance between the above-mentioned surfaces is in the range between 2 cm and 20 cm. In some aspects, the distance is set such that the detector may not detect the direct sound waves generated by the acoustic transducer. As the speed of sound or vibrations in a wooden material is about twelve times faster than in air, the wavelength of vibrations or sound in the audible frequency range lies between 35 m and 0,25 m (with sound frequencies of 100 Hz and 10 kHz).

In some aspects, the acoustic transducer is configured to generate a plurality of sound signals subsequently at different, yet at least partially audible frequencies. For instance, the acoustic transducer is configured to generate frequencies in the range of 300 Hz to 15 kHz or more particular between 500 Hz and 10 kHz or more particular between 700 Hz and 5 KHz. In some aspects, the acoustic transducer is configured to generate a sound signa of sound vibrations having a frequency chirp, that is a sound signals with an increasing or decreasing frequency covering a whole frequency range.

The acoustic transducer can be configured to generate sound signals having a base frequency and respective harmonic frequencies, although such harmonics may comprise a smaller amplitude. The noise pressure within the wooden material when being excited by the transducer may be in the range between 10-5 Pa to 5*10-3 Pa and is usually below or in the range of the audible threshold.

In some aspects, the transducer is configured to generate a plurality of sound signals at different frequencies at once. In some aspects, the transducer is configured to simulate sounds of woodpeckers. In some other aspects, the test and protection equipment comprises a second transducer, which is used to simulate sounds of one or more types of woodpeckers as proposed in this application. Consequently, the test and protection equipment according to the proposed principle is configured to produce various sounds.

In some aspects, the acoustic receiver is configured to detect sound waves or vibrations having a frequency corresponding to a frequency of sound waves or vibrations induced by the acoustic transducer into the wood piece. It is possible in this regard that the acoustic receiver is configured to detect sound produced by a woodpecker either on the pole to which the test and protection equipment is attached to or on nearby wooden poles and/or trees. This enables the test and protection equipment not only to identify possible hazardous effects on the pole, but also possible threat form woodpeckers close by. The test and protection equipment may comprise in some aspects more than one acoustic receiver, one receiver configured to detect waves in the pole, the other one to detect sounds of the environment.

Furthermore, the sensibility of the acoustic transducer may also not only include the base frequency of the acoustic transducer, but also the harmonics thereof. In some aspects, the acoustic transducer is configured to detect sound waves or vibrations in a frequency range, wherein the one or more frequencies generated by the acoustic transducer being with said range.

Some other aspects related to supplying and controlling the acoustic transducer receiver and the communication interface. In some aspects, the test and protection equipment according to the proposed principle comprises a control circuit in operative connection with the acoustic transducer and the acoustic receiver. The control circuit is configured to periodically trigger the acoustic transducer to generate the one or more audible sound waves. As the speed of sound in a wooden material is more than ten times faster than in air, the control circuit may also activate the acoustic receiver when triggering the acoustic transducer.

In some aspects, the acoustic receiver is activated prior to excitation of the wood piece to receive a noise level that can subsequently be used to improve the signal/noise ratio. In some further aspects, the control circuit is further configured to trigger the acoustic transducer to generate the one or more audible sound waves in response to a command received by the communication interface. Consequently, the control circuit is configured to initiate measurement cycles periodically or in response to a command received by the communication interface. Each measurement cycle may comprise one or more measurements with one or more individually sound signals being generate by the acoustic transducer, for example at different frequencies and/or amplitudes. In case of periodic measurement cycles, particularly at the same wood piece, the time between two consecutive measurement cycles may be long and in the range of weeks or even months, because any degradation of wooden material is usually a longer process. The periodicity between measurements can be adjusted based on the level of a possible degradation.

Similarly, the types and amounts of measurements may vary in response to a detection of a possible degradation. In some aspects, the control circuit may adjust the measurements and the sound signals based on a plurality of different parameters. The parameters may include but are not limited to the geometric dimensions of the wood piece, like length diameter, shape and the like, the type of wood, the age of wood, its current installment (i.e., whether the piece is installed in a larger structure or independent), results of previous measurements and the like.

In some further aspects, the test and protection equipment may also comprise a power supply for supplying the other elements of the test and protection equipment. In this regard, the power supply can be a rechargeable or non-rechargeable battery. In the former case, the test and protection equipment may also comprise a charging interface and/or a photovoltaic cell for recharging the battery. Using a long-lasting battery or a rechargeable battery as proposed enables to install the test and protection equipment at a certain location for a longer period of time, e.g. some years if needed. Hence, degradation of larger structures in remote areas can be detected early on, reducing significantly the number of manual inspections and costs involved in it.

In this regard, the control circuit may include a power saving mode, in which the main components of the test and protection equipment are shut down to reduce the overall energy consumption to a minimum. Furthermore, the control circuit may comprise a respective power or battery measurement device to indicate via the communication interface its current power level and if the battery needs to be replaced for example.

The communication interface comprises a wireless interface configured to communicate according to a wireless protocol. Such protocol may include, but are not limited to Bluetooth, NFC, 3G, 4G, 5G, 6G, 802.11 and the respective derivates and further developments thereof. The control circuit can comprise a non-volatile memory to store one or more measurement data in case a communication with a test and protection equipment cannot be established or the communication interface cannot establish a connection. The non-volatile memory may in some instances comprise one or more sounds of different woodpeckers. In case the acoustic receiver detects a sound, which is identified as wood-pecking by a wood-pecker, the control circuit of the test and protection equipment may load form the memory a corresponding sound and play it back through the transducer to deter the woodpecker. In some aspect, the circuit may also connect to further test and protection equipment is arranged close by via a wireless connection triggering them to play similar sounds to deter the bird.

Some further aspects concern an evaluation system for evaluating the quality of a wood piece, in particularly a pole. The evaluation system comprises the test and protection equipment as described above and a test and protection equipment. The test and protection equipment is configured to communicate, in particularly wirelessly with the test and protection equipment. The test and protection equipment may comprise a combination of hardware and software. It contains and/or utilizes a trained deep learning model fed with the transmitted values to locate at least one of position and size of a possible degradation in the wood piece. The expression “deep learning model” shall also include all “machine learning models”, and supervised or unsupervised learning models. The test and protection equipment may at partially be contained in a cloud solution.

the deep learning network can comprise a convolutional network that has been trained with a plurality of wood pieces using a ground truth that takes into account at least one of the type of wood piece, its shape and geometry, the position of a degradation, the size of the degradation, the position of the test and protection equipment on the wood piece and optionally the type of degradation. For evaluating one of the position and size of a possible degradation, one may insert some of the above parameters to improve the evaluation and reduce the parameter space. More particularly, the test and protection equipment may be configured to receive at least one of the type of wood piece, its shape (based on a list of role model shapes), its geometry (i.e. size, length, width and the like) and the position of the test and protection equipment on the wood piece as input for the trained deep learning model.

Some other aspects concern a method for evaluating a quality of an elongated wood piece and in particular a pole. More particularly, the method concerns identifying a possible damage or degradation in an elongated wood piece. The wood piece may include a pole, a flat panel and the like, but is usually elongated having a longer side, i.e. associated with the length of the wood piece and two shorter sides associated with the width and height. The method according to the proposed principle comprises the steps of inducing a in particular three-dimensional, acoustic wave or vibration of at least one audible frequency into the wood piece along one of its elongated sides. In this regard, a sound signal or acoustic wave may be induced. For the purpose of the present method, the expression acoustic wave, acoustic vibration or sound signals may be used synonymously.

In some aspects the audible frequency is in the range of a few 100 Hz, but can range between 200 Hz and 12 kHz, more particularly between 500 Hz and 7 kHz. The acoustic wave induced into the wood piece propagates through the wood piece in a three-dimensional fashion, that is it expands in all directions within the wood piece. The sound wave may reflect, bend, or otherwise disperse at obstacles and at least partially reflected thereon. The acoustic waves or vibrations reflected within the wood piece are then obtained at a location along one of its elongated sides. In some aspects, the location for inducing the acoustic waves and/or vibrations as well as the location for obtaining those are close to each other.

The method also comprises the step of providing a machine learning model trained to identify at least one of location and size of a degradation within the wood piece in response to acoustic waves or vibrations. The obtained acoustic waves or vibrations are transmitted to the machine learning model as input to the trained machine learning model. Finally, the data is used by the trained machine learning model to identify a position and/or a size of a possible degradation within the wood piece. The acoustic wave propagation within wood measured by a three-dimensional sensor has small but unique signatures that can be classified by machine learning where conventional methods of classification is used as reference in an assisted learning process.

The proposed method uses such a trained machine learning model to classify the condition of the wood piece based on an output from a transduced acoustic wave into the wood piece measured by a 1-, 2- and 3-dimensional acoustic sensor. The result is an automatic and efficient method well suited for constant remote operation as a networked sensor solution able to give up-to-date reports on the piece's structural strength in general and the piece directional strength indicated.

In some aspects, the trained machine learning model is capable of classifying a plurality of different degradations, such degradations include mechanical ones, like ruptures, cracks, cuts, notches and indentations, which are caused by environmental impact, too high stress on the wood piece or other physical events. Furthermore, the trained machine learning model may identify and classify degradations like wood rot, pest, or fungal infestation, all of which from the outside as well as within the wood piece.

In some further aspects, a location for the steps of inducing the acoustic waves or vibrations and obtaining the acoustic waves or vibrations is substantially on the same plane and substantially parallel an elongated side of the wood piece. It may be substantially in the middle of such wood piece, but can be closer to one end as well, depending on the structure to enable easier access thereto. The location for the steps of inducing the acoustic waves or vibrations and obtaining the acoustic waves or vibrations are usually close to each other and spaced apart from each other by a distance between the range of 2 cm and 35 cm and more particularly between 2 cm and 20 cm.

Some aspects concern the step of inducing acoustic waves or vibrations into the wood piece. For this purpose, one may generate a plurality of acoustic waves or vibrations subsequently at different frequencies yet at least partially audible frequencies. For instance, the step of inducing acoustic waves may generate waves with frequencies in the range of 300Hz to 15 kHz or more particular between 500 Hz and 10 kHz or more particular between 700 Hz and 5 KHz. The wave generation may follow a frequency chirp that is the acoustic waves and vibrations are generated with a smoothly increasing or decreasing frequency. Alternatively, or in addition, a plurality of waves or vibrations at different frequencies are generated at once. Hence, in some aspects, the induced acoustic waves may resemble noise or at least comprise a denser frequency spectrum with a plurality of individual frequencies. The individual acoustic waves may comprise the same amplitude but can also normalized to the same amplitude to simplify the subsequent processing thereof.

In some aspects, the method concerns inducing sounds of various animals into the environment, for example but not limited to woodpecker sounds. The type, loudness and repetition may be based on the type of woodpecker identified as described herein and particularly with regard to the determent of woodpeckers.

In some aspects acoustic waves and/or vibrations are induced in the wood having a base frequency and respective harmonic frequencies, although such harmonics may comprise a smaller amplitude. The noise pressure within the wooden material when being induced may be in the range between 10-5 Pa to 5*10-3 Pa and is usually below or just within the range of the audible threshold.

The respective at least one acoustic waves or vibrations can be induced periodically. In this regard, one may consider inducing a plurality of acoustic waves a single measurement, if such acoustic waves are induced within a short period of time, e.g. within a couple of seconds or minutes. Such measurements can then be periodically conducted, wherein the time between two of such measurements lies in the range between 4 weeks and 9 month or in particular between 2 months and 12 months. This long-time frame is based on the assumption that changes in the wood piece occur over a longer period of time and relatively slowly. Apart from sudden cracks, biological degradation take place over a longer period in the range of a few months. To check for possible degradation caused by mechanical degradations, i.e. after a storm, strong winds, sudden snowfall and the like, it is proposed to invoke the method and induce a measurement or at least one sound wave or vibration in response to a user command.

Some further aspects concern the step of identifying the location and/or size of degradation and optionally also the type of degradation as mentioned previously. For this purpose, it may be useful to provide the trained machine learning model with some additional information. Consequently, the method proposes in some instances to obtain user input related to a type of wood in the wood piece. Alternatively, or additionally, a geometry of the wood piece may be selected by a user or otherwise input to the trained model. Possible geometries may include, but are not limited to a flat panel, a pole, a beam and the like. Furthermore, a user may input the geometry of the wood piece to be evaluated. In some further aspects, the trained machine learning model may receive a position on the wood piece at which the steps of inducing acoustic wave and vibrations and/or obtaining acoustic waves takes place as an input.

The present disclosure describes among other aspects an automatic and potentially remote system and method for detecting structural changes that harms a work piece integrity and the extent and relative location of such structural changes. The test and protection equipment, test and protection equipment and method presented herein can be used on wood pieces and wooden material of all kinds of shapes or types and in fact is not limited thereto. Rather, the proposed principle is applicable to measure propagated acoustic waves and vibrations in all kinds of materials and work pieces, where a classification is possible to be performed by other conventional methods to train the machine learning models to make useful classification of the work piece integrity.

The system, the test and protection equipment as stated above can provide both functionalities as described above by combining the features into a single device. Particularly, the acoustic transducer and the receiver can be shared to offer both functions. The control circuit may implement both method. Likewise, it is possible upon identification of a woodpecker sound or upon detection of an issue in the wood to transmit such information to a remote system to identify the issue and/or the type of the woodpecker. The remote system can send information to the test and protection equipment and/or to nearby equipment for handling the issue.

Another aspect, the inventor came by lies in the finding that the mechanical stress or loads on the power line as well as other events result in detectable signals on the overhead power line. By evaluating the signal on the power line and more particularly the radiation emitted by the overhead power line, one can detect and identify certain mechanical events affecting the power line. More particularly, the radiation emitted by the power line can be easily received by an EMF antenna that can be placed afar from the actual power line. This allows a much easier and safer installation on poles along the overhead power line. For example, installing the devices on power lines poles rather than on the overhead cable itself (or very close to it as in some conventional approaches), optionally coupled with further integration of sensors capable of detecting tilt, shocks, and movements in the pole itself, furnishes a detailed diagnostic of fault type and damage magnitude. This facilitates the upfront acquisition of necessary spare parts and machinery before undertaking repairs.

It also has been found that absolute signal values are not needed. Rather, relative values can be evaluated over time and depending on the detected changes, respective measures can be taken. This enables long range sensing, e.g. by the proposed antenna, which is advantageous due to its small size, low weight and sensing range in comparison to the traditional methods of measurement, e.g. the induced magnetic field in a sensor at a short distance from the overhead cable. The antenna also permits installation outside the high-voltage zone, not disturbing power line operations during deployment.

The testing devices can be small and include a variety of the above-mentioned sensors for different applications with low-cost components, and a self-sustainability due to low power consumption provided by a rechargeable battery. Such devices can be massively and cheaply de-ployed, forming a large grid of distributed sensors that are able to communicate to a base station. The different sensors, like for instance sensors for evaluating the quality of the pole or detecting vegetation close by, enable predictive maintenance, further reducing the costs. In an aspect, the inventor proposes a testing device for contactless detection of events on a power line, in particular an overhead power line. The testing device comprises a housing having a support adapted to be permanently attached to a pole or another element close to the power line. It is suitable if the power line is attached to the pole, but this is not a requirement. An antenna element is spaced apart from the power line and adapted to detect electromagnetic radiation emitted by the power line. The testing device further comprises a detection unit arranged in the housing and connected to the antenna element. The detection unit is configured to detect a temporal and, in particular, relative change in the emitted electromagnetic radiation.

In accordance with the proposed principle, an evaluation unit is arranged in the housing. It is configured to provide information about a detected event acting on the power line in response to the detected temporal and relative change. A communication interface arranged in the housing, which is connected to the evaluation unit and configured to wirelessly transmit the detected temporal and relative change corresponding to an event or said information by the evaluation unit to an evaluation station located outside the housing.

As stated previously, this aspect can be combined in the test and protection equipment with one or more of the above-mentioned functionalities of identifying woodpecker sound close by to deter those birds and/or detect and identify possible degradation of the wooden pole. Particularly circuitry and communication interface can be shared for such purpose.

In some aspects, the evaluation unit may comprise certain patterns and threshold to which the detected change is compared to. Hence, a plurality of different patterns, each corresponding to a certain type of events, are stored in the evaluation unit. Those patterns can be defined by a machine learning model, which is trained on a variety of known patterns and their associated events. The evaluation unit may utilize the detected and preprocessed changes to either gather further information or even identify in some aspects the event acting on the power line that most likely occurred in the vicinity of the testing device's location in response to a detected temporal and relative change. In some aspects, the communication interface is configured to transmit the identified event for further analysis.

The proposed testing device can easily be installed on existing poles of power lines in safe distance from the high-voltage cable. As only changes in the radiation pattern are detected, a precise location regarding the power line is not necessary, neither must the location of testing devices on adjacent poles be the same. The detection unit is configured in some aspects to obtain at least one of amplitude information, phase information, frequency information of the received signal radiated by the power line or a combination thereof.

Certain changes or occurrences of specific signal portions can be associated with specific events or at least a group of certain events. For example, an amplitude increase of the main frequency portion of the received signal may correspond to a movement of the power line closer to the antenna unit. Higher frequency portions may be caused by coronal discharges. Further examples are presented herein further below.

Consequently, the evaluation unit is adapted in some aspects to identify at least one of the following events:
a mechanical load isolated from the earth, in particular snow or ice on the overhead power line;
a change in the length of the overhead power line between two holding points of the overhead power line, in particularly caused by temperature or a change in temperature;
a mechanical resonance in the overhead power line, particularly induced by wind;
an at least partially conductive connection, in particular in the form of vegetation close to the overhead power line, which causes a corona or sporadic micro-shorts;
current flashovers or discharges to an at least partially conductive connection near the overhead power line;
a short-circuit to earth, in particular due to vegetation coming into contact with the overhead power line;
a phase short to an adjacent overhead power line; and
a lightning strike to the overhead power line or to an element connected to the overhead power line, in particular a pole.

The proposed principle is particularly suitable for detecting mechanical loads onto the power line and events affecting the physical parameters of the power line. It helps to detect and identify events that are possibly hazardous for the power line in the future. For example, snow and ice on the power line as well as temperature changes incur mechanical stress on the power line, increasing the risk of rupture. In another example, growing vegetation can be identified as those act as a parasitic capacitance, changing the impedance along the line.

In some aspect, the received signal is filtered prior to amplifying. In some other aspects, the detection unit comprises an amplifier and an analog-to-digital converter connected thereto, with at least one digital filter connected downstream. The digital filter may comprise one or more of the following types and/or functions. For example, the filter may be implemented as a FIR filter, as an IIR filter, as an average or moving average filter. In some aspects, the filter may implement an FFT. Other filter types, like notch filter, bandpass, high-pass or low-pass filter are applicable.

In some aspects, the antenna element comprises a flat shape. In some other aspects, the antenna element comprises an elongated shape, including, for example a simple dipole antenna. In some aspects, the antenna is of a spiral shape. More complicated antennas capable of a variety of frequency bands including receiving phase information are possible.

In some aspects, the antenna element is arranged below the overhead power line, in particular at a distance of at least 1 meter. This can simplify installation and reduces the risk for workers.

Some other aspects concern the power supply of the test and protection device. The testing device may be self-sustainable, to the extent that it is not supplied by the power line itself. Rather, it may comprise an-in particular rechargeable-energy storage, which is connected to the detection unit, the evaluation unit and the communication interface for supplying those units. The energy storage may be sufficiently large to supply the testing device for a plurality of years. This will reduce the requirements for changing the battery. Furthermore, the testing device may comprise a solar panel attached to the housing for charging the energy storage device.

The testing device can also implement further sensors to be able to obtain a plurality of different information related to environmental aspects, possible hazards or quality measures of the pole. In some aspects, the testing device may further comprise an accelerometer for detecting a mechanical event that triggers movement of the housing above a threshold acceleration or threshold velocity. For example, the accelerometer may be triggered, as the pole falls down, breaks or even when the power line is ruptured causing vibrations on the pole.

In some other aspects, the testing device may further comprise an acoustic transducer arranged in the housing and configured to induce one or more audible acoustic waves into a portion of the pole, in particular a wooden pole, said portion in connection with the housing. The housing further comprises an acoustic receiver disposed in the housing configured to detect acoustic signals from the portion of the pole, the acoustic signals comprising portions of the induced acoustic waves reflected at interfaces of the pole.

Such an approach enables the testing device not only to detect events affecting the power line but also provide information about the quality of the pole and possible degradation thereof. For this purpose, the communication interface is arranged to communicate information derived from the sound signals detected by the acoustic receiver to an evaluation system located outside the housing.

In some further aspects, the testing device may comprise an acoustic transducer arranged in the housing and configured to play woodpecker sounds onto the pole or the environment, i.e. into the surrounding. The playback may be triggered upon identifying woodpecker sound in the vicinity. For this purpose, the housing comprises an acoustic receiver in the housing configured woodpecker sounds. Upon detection, an evaluation unit in the housing may identify at least one of woodpecker species based on the sound, the type of sound, distance and optionally other parameters.

Such an approach enables the testing device not only to detect events affecting the power line but also provide information about the quality of the pole and possible degradation thereof as well as woodpeckers in the vicinity. For this purpose, the communication interface is arranged to communicate information derived from the sound signals detected by the acoustic receiver to an evaluation system located outside the housing.

To increase the up-time and reduce power consumption, the test and protection equipment is further arranged to activate the detection unit at predetermined, in particular periodic, times. In case other sensors are included, the test and protection equipment is further arranged to trigger the acoustic transducer periodically to generate the one or more audible acoustic waves. In some aspects, the test and protection equipment is further adapted to activate the detection unit and/or the acoustic transducer in response to a command received from the communication interface. In summary, the test and protection equipment may include a plurality of sensors to obtain various environmental and system information. This reduces the costs but maintains the flexibility. Predictive maintenance becomes possible. Further, an identified event reduces the number of spare parts to be transported to the side.

In some aspects, the test and protection equipment may periodically or even continuously listen to the environment to identify woodpecker sounds.

Some other aspects concern an evaluation system for evaluating events on an overhead power line, in particular a power line. The evaluation system comprises at least one test and protection equipment to the proposed principles either alone or in combination as outlined herein. Each test and protection equipment is attached to a respective pole of the power line. The evaluation system also comprises an evaluation station configured to communicate,—in particular wirelessly—, with the testing device. The evaluation station is configured to identify the event using a trained deep-learning model, to which the detected temporal and relative change or the information about the detected event is applied.

In some further aspects, the evaluation station is configured to locate, using a trained machine learning model, at least a position and a severity of possible damage to the pole based on information derived from the acoustic signals detected by the acoustic receiver. Various other models can be used and individually trained. Furthermore, parameters of the trained models can be continuously adjusted to improve predicting and event identification.

In some aspects, the evaluation system according to the proposed principle is configured to identify the above-mentioned events. A deeper analysis can be performed by the evaluation station using a trained deep model in order to prioritize measures like visual checks, maintenance, removal of vegetation close to the power line repair and the like. Several deep learning models can be combined, or the information split into several model, those models trained for identifying the species of woodpeckers, the type and amount of degradation and the event as outlined herein.

It has been further observed that wood pieces may carry sound differently in regard to its internal structure and composition. More particularly, sound in a wood piece propagates with different speeds, differently along the wooden fibers and perpendicular to the fibers. Furthermore, the speed of sound or vibrations within the wooden material is based on the wood type, i.e., the annual wood rings, but not so much of its density. The speed of sound in a wooden material ranges between 3500 m/s to about 5000 m/s, so it is approximately 10 to 15 times faster than the speed of sound in air.

When the sound wave propagating trough the wooden material hits an area with different characteristics, like for instance a tight knot (e.g. a former branch knot), propagation changes. Likewise, damages at certain locations as well as degradation, i.e., caused by mold growth within the wooden material, vermin or bacteria induced decay change the acoustic behavior characteristics and propagation of sound waves. For instance, sound waves propagating through the wood are reflected differently at damage or rotten parts of a wood piece than on an intact portion of the material. Similarly, the inventor proposes to initiate vibration within a wood piece, which usually resonates in a certain manner. Such resonance changes under degradation, where the change reflects the strength as well as the position of the degradation in the wood piece. For the purpose of the present application, the expression “resonance” shall include any response of a wood piece when being excited by a vibration. Said vibration can include a mechanical or an acoustic excitation.

Consequently, the inventor utilizes those characteristics to not only detect possible degradation in a wood piece, but also identify the location and possible size of the degradation using sound waves through the wood pieces to be tested and evaluated. The expression degradation in this regard shall represent any deviation from the norm, which includes any damage to the wood piece. Such degradation may include, but is not limited to physical damages, like ruptures or cracks, cuts, notches, or indentations, but also damages like rot, fungal infestation on the wood and the like.

As such degradation in wooden structures is usually increasing over a longer period and strongly influenced by environmental parameters, the inventor proposes that the above-mentioned testing device implements further sensors for measuring the quality and the status of the pole to which the testing device is attached to.

All these aspects can be realized by a relatively small energy efficient electronic system in accordance with the proposed principle that is placed at a permanent position on a wooden object. Said electronic system is typically part of a larger number of assets in a wide geo-graphic area that can operate remotely and automatic by reporting the wooden objects structural integrity and its development over time. Such a system is able to replace today's manual methods to provide timidly alerts ensuring the safety and performance and to create predictive models as an asset management system over time.

The testing device comprises in some further aspects a sensor surface, said sensor surface configured to be attached to a wood piece, particularly an elongated wood piece on the elongated side thereof. The testing device in accordance with the proposed principle further comprises an acoustic transducer. The acoustic transducer is configured to generate one or more audible sound waves and induce said sound waves into the wood piece. For such purpose, the acoustic transducer is in operative connection with the sensor surface to induce a generated audible sound wave into the wood piece attached thereto.

Furthermore, the test and protection equipment comprises an acoustic receiver in operative connection with the sensor surface. The acoustic receiver is configured to detect sound signals, wherein the sound signals comprise portions of the induced sound waves reflected at interfaces of the wood piece. In some aspects, the acoustic receiver is configured to detect vibrations of or within the wood piece. In some further aspects, the acoustic receiver is configured to detect environmental sound, in particular bird sounds, like the ones from woodpeckers. Finally, the acoustic receiver is coupled to the communication interface. The detected sounds may be identified before providing such information to the communication interface.

The test and protection equipment presented herein is capable of inducing a three-dimensional sound waves into the wood piece and subsequently detecting the reflected portions in three dimensions as well. This multidimensional measurement enables locating the size of a possible degradation of the wooden material at any location of the wood piece. The transducer and the receiver are positioned in the same casing close to each other and more particularly connected to the same surface, which enables a small and compact box. Consequently, the testing device is not only portable, but can actually adjoin to the wood piece to be evaluated and measured.

Together with the other sensors, a plurality of such test and protection equipment can be placed throughout a large area providing various kinds of information in regard not only to the electrical power lines, but also the poles to which the power line is attached to. This may enable predictive maintenance, precise location of possible faults and generally harvesting all kinds of environmental data and information, which can serve further purposes. These test and protection equipment can also be used to identify woodpeckers in a large areas and subsequently produce sound to deter the birds away.

In some aspects, the acoustic transducer is configured to generate a plurality of sound signals subsequently at different, yet at least partially audible frequencies. For instance, the acoustic transducer is configured to generate frequencies in the range of 300 Hz to 15 kHz or more particular between 500 Hz and 10 kHz or more particular between 700 Hz and 5 KHz. In some aspects, the acoustic transducer is configured to generate a sound signa of sound vibrations having a frequency chirp, that is a sound signals with an increasing or decreasing frequency covering a whole frequency range.

The acoustic transducer can be configured to generate sound signals having a base frequency and respective harmonic frequencies, although such harmonics may comprise a smaller amplitude. The noise pressure within the wooden material when being excited by the transducer may be in the range between 10-5 Pa to 5*10-3 Pa and is usually below or in the range of the audible threshold. In some aspects, the transducer is configured to generate a plurality of sound signals at different frequencies at once.

In some aspects, the acoustic receiver is configured to detect sound waves or vibrations having a frequency corresponding to a frequency of sound waves or vibrations induced by the acoustic transducer into the wood piece. In this regard, the sensibility of the acoustic transducer may also not only include the base frequency of the acoustic transducer, but also the harmonics thereof. In some aspects, the acoustic transducer is configured to detect sound waves or vibrations in a frequency range, wherein the one or more frequencies generated by the acoustic transducer being with said range.

Some other aspects are related to supplying and controlling the various elements including the acoustic transducer receiver, antenna amplifier, detection and evaluation unit and the communication interface. In some aspects, the test and protection equipment according to the proposed principle comprises a control circuit in operative connection with the respective elements. The control circuit is configured to periodically trigger the acoustic transducer to generate the one or more audible sound waves. The control circuit may also be configured to trigger the reception path of the antenna to receive and subsequently detect the signal emitted by the power line.

Consequently, the control circuit is configured to initiate measurement cycles periodically or in response to a command received by the communication interface. Each measurement cycle may comprise one or more measurements with one or more of the above-mentioned sensors. In the case of periodic measurement cycles, the time between two consecutive measurement cycles may vary on the sensor type. In the case of the power line measurement, the cycle may be in the range of hours and also depend on time of day, annual season or triggered by other environmental data, e.g. wind or rain sensors. In cases of measurements on the wooden piece, the period may be long and in the range of weeks or even months, because any degradation of wooden material is usually a longer process. The periodicity between measurements can be adjusted based on the level of a possible degradation. In case of detection of sound, one may periodically switch on the acoustic receiver, e.g. during time, when woodpeckers are usually active.

Similarly, the types and amounts of measurements may vary in response to a detection of a possible event or degradation.

In some further aspects, the testing device may also comprise a power supply for supplying the other elements of the testing device. In this regard, the power supply can be a rechargeable or non-rechargeable battery. In the former case, the testing device may also comprise a charging interface and/or a photovoltaic panel for recharging the battery. Using a long-lasting battery or a rechargeable battery as proposed enables to install the testing device at a certain location for a longer period of time, e.g. some years if needed.

In this regard, the control circuit may include a power saving mode, in which the main components of the testing device are shut down to reduce the overall energy consumption to a minimum. Furthermore, the control circuit may comprise a respective power or battery measurement device to indicate via the communication interface its current power level and if the battery needs to be replaced, for example.

The communication interface comprises a wireless interface configured to communicate according to a wireless protocol. Such protocol may include, but are not limited to Bluetooth, NFC, 3G, 4G, 5G, 6G, 802.11 and the respective derivates and further developments thereof.

The control circuit can comprise a non-volatile memory to store one or more measurement data in case a communication with a test and protection equipment cannot be established, or the communication interface cannot establish a connection.

The proposed invention uses such a trained machine learning model to classify the events, the likelihood thereof and/or the condition of the wood piece based on an output from a transduced acoustic wave into the wood piece measured by a 1-, 2- and 3-dimensional acoustic sensor. The result is an automatic and efficient method well suited for constant remote operation as a networked sensor solution able to give up-to-date reports on the power line structure, both on the power line itself and any wooden structure to which the power line is attached.

In some aspects, the trained machine learning model is capable of classifying a plurality of different events, such events being mechanical one like resonance, breaking of the power line or one of the poles, branches or trees touching the power line or getting too close, pressure on the power line by snow and ice and so on. Likewise, similar trained networks can be used to detect mechanical issues with the poles, like ruptures, cracks, cuts, notches and indentations, which are caused by environmental impact, too high stress on the wood piece or other physical events. Furthermore, the trained machine learning model may identify and classify degradation like wood rot, pest, or fungal infestation, all of which from the outside as well as within the wood piece. Once trained, the model can be used either remotely and embedded into each testing device to directly evaluate and identify possible hazardous events or integrated in a centrally administered database and event identification center.

### SHORT DESCRIPTION OF THE DRAWINGS

Further aspects and embodiments in accordance with the proposed principle will become apparent in relation to the various embodiments and examples described in detail in connection with the accompanying drawings in which

FIG. 1a to 1d show a principal drawings of a pole with a test and protection equipment attached to it as well as embodiments of various pieces of wood and possible damages thereto and a power grid structure;

FIG. 2 illustrates a principle drawing of an apparatus for acoustic deterrent targeting individual woodpecker species according to some aspects of the proposed principle;

FIG. 3 shows an embodiment of a test and protection equipment attached to a pole according to some aspects of the proposed principle;

FIG. 4 shows a second embodiment of a test and protection equipment according to some aspects of the proposed principle for attachment to a piece of wood or a pole;

FIG. 5 illustrates a third embodiment example of a test equipment and protection according to some aspects of the proposed principle, for attachment to a pole;

FIG. 6 illustrates a schematic embodiment of a test and protection device in accordance with some aspects of the proposed principle;

FIG. 7 shows a further embodiment of a test and protection device and arrangement according to some aspects of the proposed principle;

FIG. 8 illustrates a yet another embodiment example of a test and protection device according to some aspects of the proposed principle, for attachment to a pole;

FIG. 9 is a flow diagram of a method for acoustic deterrent targeting individual woodpecker species according to the present invention;

FIGS. 10 to 12 show various signals and parts of the signal processing illustrating some aspects of the proposed principle;

FIGS. 13A and 13B show various signals and parts of the signal processing, illustrating some aspects of the proposed principle;

FIG. 14 is an embodiment of a method according to some aspects of the proposed principle, suitable for training a machine-based model;

FIG. 15 shows another embodiment of a method according to some aspects of the proposed principle;

FIG. 16 describes some further aspects of a method according to the proposed principle;

FIG. 17 is a time diagram showing the progression of some signal in a piece of wood;

FIGS. 18A to 18C are representations of a Fourier transform of signals from FIG. 17 to explain some aspects of the proposed principle;

FIG. 19 shows an embodiment of a method according to some aspects of the proposed principle.

### DETAILED DESCRIPTION

The following embodiments and examples disclose various aspects and their combinations according to the proposed principle. The embodiments and examples are not always to scale. Likewise, different elements can be displayed enlarged or reduced in size to emphasize individual aspects. It goes without saying that the individual aspects of the embodiments and examples shown in the figures can be combined with each other without further ado, without this contradicting the principle according to the invention. Some aspects show a regular structure or form. It should be noted that in practice slight differences and deviations from the ideal form may occur without, however, contradicting the inventive idea.

In addition, the individual figures and aspects are not necessarily shown in the correct size, nor do the proportions between individual elements have to be essentially correct. Some aspects are highlighted by showing them enlarged. However, terms such as “above”, “over”, “below”, “under” “larger”, “smaller” and the like are correctly rep-resented with regard to the elements in the figures. So it is possible to deduce such relations between the elements based on the figures.

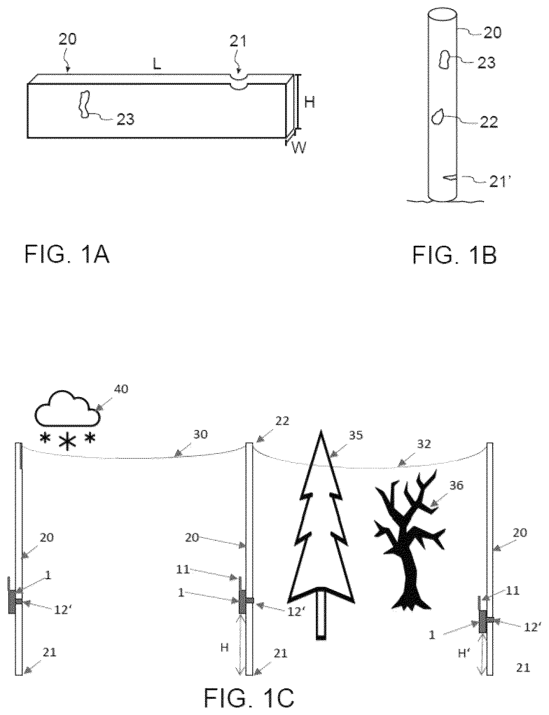

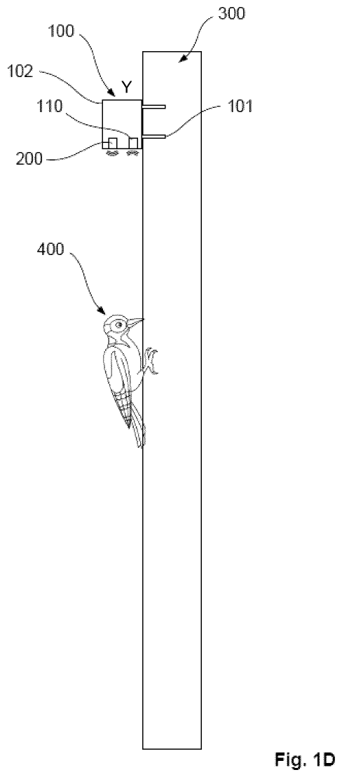

FIGS. 1A and 1B illustrate the different wood pieces, their quality and possible degradation which can be measured in accordance with the proposed test and protection equipment and the method thereof. FIG. 1A illustrates a wooden plank comprising the length L, the height H as well as the width W. As illustrated, the wooden plank is elongated, wherein the length L comprises the highest dimension compared to the height and width W. These wooden planks can come in different sizes as well as different shapes. FIG. 1B illustrates another wooden piece in the shape of a round pole, which is standing upright and is fixated with its bottom part at the ground level.

Both wood pieces 20 comprise different types of degradation and damages illustrated herein. More particular, wooden plank 20 in FIG. 1A comprises an indentation 21 along its elongated side L as well as a small area 23 of the pest infestation. While the indentation 21 is of pure mechanical and physical origin, for example by hitting the wooden plank in the area 21, the pest infestation in region 23 is of the biological origin, caused by a higher level of humidity in that region, followed by an infestation by vermin, which subsequently decomposes the wooden material in said region 23. As a result of those damages, the stability both for the indented area 21 as well as for the infested area 23 will degrade resulting in a reduced stability and lifetime of the wooden plank.

Another degradation that is not shown on the wood piece is related to holes or openings made by woodpecker on the pole. While other degradation occurs over a longer time period, the holes made by the wood-pecker are made in very short time and even if not completed can form the entry for fungal infestation and other rot as detailed below. Hence it is suitable to detect such damage early on and in the present case not the damage as such, but the actual act leading to the damage.

The wooden pole 20 in FIG. 1B also comprises several types of the degradation. In the bottom part, the wooden pole 20 comprises a crack 21′, which may be caused by physical hit or pressure towards the pole 20. Similar to the indentation 21, the crack 21′ is most usually caused by physical or mechanical harm and sudden stress to the wood piece.

Furthermore, the pole comprises a fungal infestation at region 22 on the outer surface. The fungal infestation usually grows within the wood pole 20, thereby reducing the stability. Furthermore, a vermin infestation 23 is located at the upper portion of the wood pole. The pest infestation takes place inside the material of the pole beneath its surface and is not necessarily visible on the outside. Consequently, the stability of the pole degrades from within in that area, while the fungal infestation as well as the crack 21 is visible from the outside.

The different degradations of the respective wooden material are only partially recognizable by physical inspection. While cracks, ruptures, indentations, and similar mechanical harm can be visually recognized, fungal infestation, wood rot or pest infestation is more difficult to visually identify, particularly if the respective spot is covered. Furthermore, any mechanical element attached to the wood piece or pole may act as a source of potential degradation from within the wooden material itself which cannot be recognized until the size of such degradation reaches the outer surface.

FIG. 1c illustrates an exemplary environment, in which one or more testing devices for detection of events and its possible identification in a power line can be applied to. The environment illustrates a plurality of poles 20, upon which one or more power lines 30 are attached to. The power lines are spaced apart from each other and firmly anchored into the soil or ground at the bottom level 21. A plurality of power lines 30 are attached on top 22 of each of poles 20 and fixed thereupon. The power lines are isolated from the ground and from each other. In this regard, a pole 20 may be formed of the wooden material, implemented for instance as a wooden pole.

The power lines 30 are attached to each pole with a certain variation and fluctuations of providing a sag formed as indicated in FIG. 1. This sagging depends on the plurality of environmental parameters, which can cause the power line to further sag and even change its length significantly. For example, due to environmental changes like temperature changes either caused by current through the power line or external heating for example during seasonal changes, the cable length of the power lines is decreasing or increasing. Furthermore, any weight on the power line caused by snow or ice may further sag the power line towards earth. It has been observed that in a conventional power lines, these changes in length between the different poles can cause a significant variation in the range of a couple of 10 of centimeters and even meters in height. In other words, the power lines subject to their own weight, environmental changes and additional pressure exerted on those may sag significantly towards earth and possible either become a danger for livestock and humans or get close to existing vegetation.

Furthermore, bushes, trees and other vegetation indicated herein with references 35 and 36 can influence and affect the power lines. For example, growing vegetation may get in contact with power lines, resulting in a short circuit on the line. However, even if not in contact, small partial discharges can affect the power line as well as the capacitance may change, when leaves, branches or other material is getting too close to the line.

Generally, the expression partial discharge or PD refers to localized electrical discharges that partially bridge insulation between conductors when the insulation is stressed by high voltage. They can occur in any type of high-voltage insulation system, including transformers, power cables, switchgear, but also stator windings of large motors and generators.

The breakdown of an insulator's ability to insulate high voltage in power lines can also cause partial discharge events. In this regard, there are different types of insulators, which are used for different purposes and power lines. Detecting this phenomenon in a timely manner can prevent further deterioration of the insulators.

Finally, wind, storms as well as lightning strikes in the vicinity may significantly affect the power line and subsequently cause damage either to the line itself or work pieces attached thereto. For example, wind induced mechanical resonance, commonly referred to as galloping lines, may cause damage to the pole and the power line.

For this purpose, the present application proposes a testing device to detect and evaluate the status of the power line as well as its physical properties and characteristics. Any of the above changes in the environment, referred to as events and affecting the power line, can be subsequently detected by evaluating the current through the line itself using a contactless measurement approach.

As a result thereof, the inventor proposes a new test and protection equipment and method which can
identify the presence of woodpeckers which can cause significant harm to any wooden structure, and take appropriate action to deter the bird;
identify the location of possible degradation, allowing a user to subsequently inspect and survey the respective area of wooden material; and
detect and identify events that affect the load capacity of the power line.

The proposed equipment and method are particularly suitable for remote wooden objects, which are otherwise difficult to reach and to inspect. Hence, maintenance of such objects is proposed to be partially automated by such test and protection equipment, which provide an alert if a degradation of mechanical or biological origin is detected or reaches a certain threshold.

Reference is now made to FIG. 1d showing a principle drawing of a test and protection equipment 100 in accordance with main aspects of the proposed principle, including the detection and deterrent of woodpeckers, the detection of possible degradation and the measurement instrument for detecting changed on the overhead powerlines. In FIG. 1d is shown a principle drawing where a test and protection equipment 100 according to the proposed principle is arranged on or near a structure 300 to be monitored by suitable attachment means 101, such as bolts or similar. In FIG. 1d is further shown a woodpecker 400 pecking on the structure 300.

In FIG. 1b is shown a block diagram of the test and protection equipment 100 according to the proposed principle. The test and protection equipment 100 according to the proposed principle comprises at least one sensor array 110 comprising at least one acoustic sensor 111 configured to register (measure) acoustic signal data of pecking from woodpeckers 400 on the structure 300 or associated parts as shown in FIG. 1d. In some aspects, the at least one acoustic sensor 111 is directed towards the environment. In some other aspects at least one acoustic sensor 111 is attached to the pole, thereby configured to detect soundwaves propagating through the pole. This would allow the device not only to detect woodpecker noises close by, but also directly identify wood-pecker at the pole to which the test and protection equipment is attached to. The at least one acoustic sensor is also configured to detect other sound waves, e.g. induced by a transducer into the pole as explained herein.

The test and protection equipment 100 comprises a control unit 120 configured, provided with means and/or software, to process the registered acoustic signal data into datasets. This control circuit can also implement the functionalities as explained further below. Although not shown herein, the test and protection equipment comprises a transducer being configured to induce sound waves into the pole to which the test and protection equipment is attached to and an antenna to receive the electromagnetic radiation from the overhead powerline.

In accordance with the present invention, the test and protection equipment 100 further compresses an internal or external memory 130, in the shown embodiment integrated in the control unit 120, which memory 130 is used for storing the registered acoustic signal data after processing by the control unit 120 as data sets in the internal or external memory 130.

The control unit 120 according to the proposed principle is configured, by comprising means and/or software, to determine the species of woodpeckers 400 involved based comparing the registered acoustic signal data with patterns, signals or signatures unique for each woodpecker species stored in a database in the internal or external memory 130. In accordance with a preferred embodiment of the present invention, the proposed principle makes use the pecking as it is registered in the monitored structure 300 or associated parts, and the database this comprises patterns, signals or signatures of such pecking.

Other examples of patterns, signals or signatures that are used for determining the woodpecker species involved that may be used in addition or instead of the former are:
sounds like churrs, purrs, rattles, chatters, screeches, and other short sounds, such as “peek” and “pik” notes, and/or
tempo, rhythm, duration, and repetition of drumming patterns or signatures.

Other unique patterns, signals or signatures will be within the knowledge of a skilled person.

According to the proposed principle, the control unit 120 is further configured, by comprising means and/or software, to determine the type of activity of the involved woodpecker 400 based comparing the registered acoustic signal data with patterns or signatures unique for each type of activity stored in the same or different database in the internal or external memory 130. Drumming and work pecking are examples of two types of activities with different patterns, signatures, signals, etc. that one should distinguish between. Examples of patterns, signals or signature of woodpecker activity that are used for determining the activity according to the present invention, are tempo, rhythm, duration, and repetition of drumming patterns or signatures, as well as volume. Other unique patterns, signals or signatures will be within the knowledge of a skilled person.

The control unit 120 is further configured, by comprising means and/or software, to, based on the determined woodpecker 400 species and type of activity, chose a targeted deterrent action from available deterrent actions stored in the same or separate database in the internal or external memory 130.

The test and protection equipment 100 according to the proposed Principle further comprises at least one acoustic deterrent emitter 200 configured to emit chosen deterrent acoustic signals to deter the identified woodpecker 400 species.

In accordance with the test and protection equipment 100 according to the present invention, the control unit 120 is configured, by comprising means and/or software, to control settings of the at least one acoustic deterrent emitter 200 to emit a targeted deterrent signal according to the chosen targeted deterrent action to deter the identified woodpecker 400 species.

According to a further embodiment of the test and protection equipment 100 according to the present invention, the at acoustic sensors 111 of the at least one sensor array 110 are configured to register acoustic signals data of pecking that create vibrations propagating in the monitored structure 300 or associated parts.

In accordance with a further embodiment of the apparatus according to the proposed principle the acoustic sensors and/or control unit is configured, by comprising means and/or software, to filter out soundwaves via the surrounding air that may disturb the acoustic sensor measurements or deteriorate determination of the woodpecker 400 species. In this manner one also provides a coarse filtering of the registered acoustic signal data, reducing the load of the control unit 120.

According to a further embodiment of the test and protection equipment 100 according to the present invention, the test and protection equipment 100 further is configured for machine learning. In accordance with one embodiment the test and protection equipment 100 comprises a separate machine learning module 140, while in an alternative embodiment the machine learning is integrated in the control unit 120. According to the present invention, the separate machine learning module 140 or control unit 120 is configured, by comprising means and/or software, to perform machine learning. In accordance with one embodiment of the proposed principle the machine learning comprises classifying the datasets by assistive learning of the registered acoustic signal data from the at least one sensor array 110 to identify the type of activity performed by the woodpecker 400 and if it is causing damage to the structure 300 or associated parts, and/or noise.

In accordance with one embodiment of the test and protection equipment 100 according to the present invention, machine learning module 140 or control unit 120 machine learning is configured to determine the type of pecking activity of the involved woodpecker 400 species based on stored patterns or signatures unique for each activity in the same or separate database in the internal or external memory 130.

According to a further embodiment of the test and protection equipment 100 according to the present invention, the machine learning module 140 or control unit 120 machine learning is configured to determine the woodpecker 400 species involved based on stored patterns or signatures unique for each woodpecker 400 species in the same or separate database in the memory 130.

In accordance with one embodiment of the test and protection equipment 100 according to the present invention, the machine learning module 140 or control unit 120 machine learning is configured to perform training using a set of historical acoustic signal data of woodpeckers 400 pecking and configured to adapt and update its analysis and responses, i.e. targeted deterrent signal settings, based on new acoustic sensor signal data as it is received.

According to one embodiment of the test and protection equipment 100 according to the present invention, the at least one acoustic deterrent emitter 200 is arranged on or near the monitored structure 300 and configured, by comprising at least one transducer 201 or loudspeaker, emitting a targeted deterrent signal in the form of natural sounds tailored to deter the identified woodpecker species from causing further activity.

According to a preferred embodiment f the present invention, the deterring sound(s) is/are of woodpecker within the same or different species.

Other examples of deterring sounds that may be used in addition or instead of the former are sounds of natural enemies of the woodpeckers, such as cries of hawks, owls or eagles and other predators, other sounds that the woodpecker finds annoying, such as loud noises of banging pots or pans, human voices yelling, bird distress calls, frequency or volume of the emitted sounds, etc. Other deterring sounds will be within the knowledge of a skilled person.

In accordance with a further embodiment of the test and protection equipment 100 according to the present invention, the at least one acoustic deterrent emitter 200 is activated based on the output of the separate machine learning module 140 or control unit 110 and is configured to be adjusted or disabled as needed.

According to one embodiment of the test and protection equipment 100 according to the proposed principle the test and protection equipment 100 is configured for real-time or near real-time monitoring and deterrent of woodpecker damage and noise.

In accordance with one embodiment of the test and protection equipment 100 according to the present invention, the components of the test and protection equipment 100 are joined in a housing 101 protecting the components, with associated slits or perforations for the at least one acoustic sensor array 110 and acoustic deterrent emitter 200. Alternatively, one or more of the components are arranged in separate housings, as well as the test and protection equipment 100 may be provided or arranged to remote acoustic sensor arrays 110 and acoustic deterrent emitters 200. In addition, two or more apparatuses 100 arranged within a communication range may cooperate both for the registration, determination and deterring of the woodpeckers.

In a further embodiment of the test and protection equipment 100 according to the present invention, the apparatus further comprises a wireless communication unit 150 enabling communication with external units, such as tablets, computers, phones or sky-services, for reporting and/or providing a user interface for controlling the settings of the control unit 140, acoustic sensor array 110 and/or acoustic deterrent emitter 200. In addition, the test and protection equipment 100 itself may be provided with a display for providing a user interface. The test and protection equipment 100 is further provided with an internal or external energy storage 160, such as one or more batteries, alternatively or in addition, connected wired energy supply systems if present and accessible. In accordance with a further embodiment of the test and protection equipment 100 according to the present invention, the test and protection equipment 100 comprises energy harvesting means (not shown), such as solar panels, enabling charging of the energy storage 160.

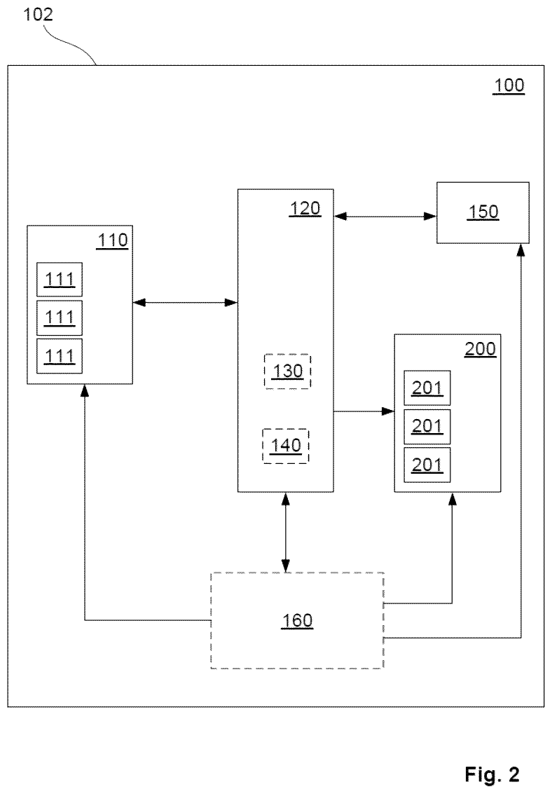

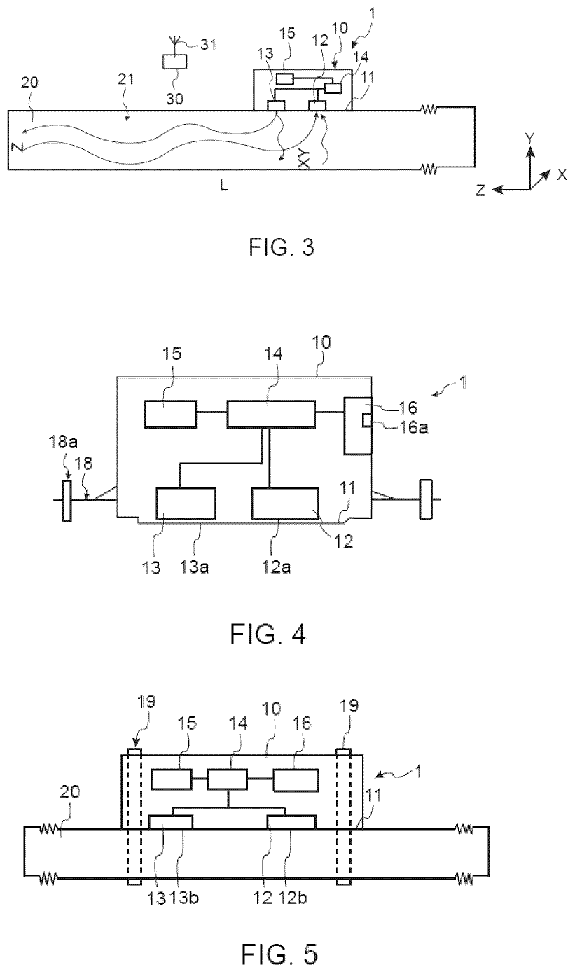

FIG. 2 illustrates an embodiment of a test and protection equipment in accordance with some aspects of the proposed principle. In this embodiment, only the part for detection physical changes on the rod is explained. However it is understood that the above-mentioned acoustic sensors can be implemented in this embodiment. Likewise, the circuitry can be extended and configured to implement the above-mentioned functionality.

The wooden workpiece 20 having length L, width W as well as height H is provided. The length L runs along the Z-direction, while the width and height of the respective wood piece 20 extend in the X-and Y-direction, respectively. A test and protection equipment box 1 is firmly attached to the outer surface of the wood piece 20. Test and protection equipment 1 comprises casing 10, in which a transducer element 13 is arranged. The transducer element 13 is configured to emit acoustic sound waves directly into the wood piece 20. For this purpose, the transducer 13 is located at the bottom part 11 of casing 1 in direct connection to the surface of wood piece 20. As illustrated in FIG. 2, the transducer 13 induces acoustic waves in all three directions X, Y and Z having a dedicated frequency in the audible range that is between 200 Hz and 15 kHz. The audible frequency is adjustable depending on the set-up and other parameters of the workpiece 20.

Test and protection equipment 1 further comprises an acoustic receiver 12 in casing 10 similar to the transducer 13. The acoustic receiver 121 is directly attached to the outer surface of the wood piece 20 configured to receive any acoustic wave propagating on the wood piece's surface. A control circuit 14 in casing 10 is connected to the acoustic transducer 13 as well as to the acoustic receiver 12 and a communication interface 15. The communication interface 15 is implemented as a wireless communication interface capable of receiving and transmitting data using a wireless network protocol like 3G, 4G and 5G or the derivates therefrom. In very remote locations the communication interface may utilize a satellite communication network. Consequently, the test and protection equipment 1 can be attached to any wood piece 20 in a remote location.

The control circuit 14 periodically triggers in operation of the device the acoustic transducer 13 to emit one or more acoustic waves of a single or different frequencies into the wood piece 20 as illustrated in FIG. 2. The induced acoustic waves propagate through the wood piece 20 in all three directions and are reflected at least partially at certain interfaces within the wood piece. In case of the present embodiment, an indentation or crack 21 is located on the left side of the test and protection equipment 1 in the wood piece 20. This indentation will change the reflective or transmissive behavior of the acoustic wave in this direction, resulting in a change of the reflected wave subsequently received by the acoustic receiver 12 in regard to a “healthy wood piece”. The reflected acoustic wave is subsequently received by the acoustic receiver 12 and converted into a respective signal.

In this regard, acoustic receiver 12 is configured to receive acoustic waves or vibrations from all three directions individually as indicated and as such can generate different signal therefrom. The received signals are forwarded to the control circuit 14, which subsequently triggers the communication interface 15 to transmit the information to an evaluation unit 31 with a receiving antenna 31. The evaluation unit makes use of the same communication protocol as interface 15. For example, the evaluation unit 30 is located close to a cloud or another facility providing computational power. The facility establishes a hub for example to receive and evaluate a plurality of signals from various test and protection equipment at different remote locations.

The evaluation unit 30 now utilizes a trained machine learning model to determine the state of the wood plank 20. This also implies that the trained machine learning model also determines possible sound made by woodpeckers in the vicinity and can even determine its species. Such detection enables the test and protection equipment to act early on deterring the bird even before significant harm is done to the pole.

In a stable and intact wood piece 20, the acoustic waves are usually reflected at the interfaces that is the edges of the respective wood piece in a certain manner which is independent of, for instance, the type of wood. However other parameters like the geometric dimensions as well as the shape and form of the wood piece as well as the location of the test and protection equipment at the piece influence the shape and form of the acoustic waves propagating through the piece. These characteristics are fed into the trained machine learning model and compared with the received data using a model with a plurality of various layers. In case of an intact wood piece, the machine learning model recognizes a strong correlation and provides the respective information to a user. In the given case with the indentation and crack 21, the reflective behavior of the wood piece 20 changes and deviates from an intact piece of the same or similar geometric size and proportion. In some instances, the reflective behavior may even be characteristic for the damage on the wood piece irrespectively of some of the above-mentioned parameters.

Consequently, the deviation is recognized by the trained machine learning model based on the characteristics of different types of degradations as well as their sizes and locations thereof. For example, the acoustic wave in the Z-direction will be partially reflected at the indentation 21′ indicating a change of the length or deviation in the length of the wood piece towards the left side of the test and protection equipment 1. The characteristics are evaluated by the trained machine learning model and provided to the user. In contrast to conventional test and protection equipment and methods, the present test and protection equipment 1 is located with its transducer and acoustic receiver in a single casing, which can be attached by various means to a wood piece in a remote location. This will allow to provide a plurality of such test and protection equipment onto several wooden objects in a larger area and evaluate the quality of the respective wood pieces in that area. Depending on the nature of the degradation, one can monitor a large are, e. g. of forest, wooden structures and the like without the need of being physically present or measuring and inspecting each wood piece individually.

For this purpose, test and protection equipment 1 can be implemented in various shapes, forms and sensor surfaces 11 configured to be attached to the surface of the respective wood piece(s). In this regard, the sensor surface can comprise a flexible material following the shape of the wood piece to be attached to. Such flexible material, for example, a plastic material or a rubber material will ensure a direct attachment to the surface of the wood piece to transfer the acoustic waves from the transducer into the wood and the reflective waves towards the acoustic receiver.

FIG. 4 illustrates another embodiment in accordance with the proposed principle. Test and protection equipment 1 comprises a casing 10 with a slightly elevated sensor surface 11 adjacent to the wood piece. The sensor surface 11 is made of the flexible material different to material of the other outer surfaces of the casing 10. The sensor surface 11 further comprises a detector surface 12a being part of an acoustic receiver 12 as well as the transducer surface 13a being part of a transducer 13. In other words, transducer 13 as well as receiver 12 are both embedded within the sensor surface 11 to be directly attached to the wood piece. Casing 10 further comprises a control and supply circuit 14 connected to the receiver 12 and transducer 13. A rechargeable battery 16 provides the necessary power to all elements in casing 10 and is also coupled to a charger element and plug 16a for recharging the battery if needed. A communication interface 15 is connected to receiver 12 and transducer 13 via the control circuit 14.

Test and protection equipment 1 further comprises an attachment element 18, including two screw extensions 18 with screws 18a for screwing the test and protection equipment 1 with its sensor surface 11 to the surface of the wood piece. In operation of test and protection equipment 1, the user screws the test and protection equipment tightly to the wood piece and mark of the respective relative location of the test and protection equipment in regards to the geometry and shape of the wood piece. This information is used as an input for the machine learning model later on to detect a possible damage or degradation of the wood piece. Control circuit 14 periodically triggers the transducer 13 to induce acoustic waves and vibrations into the wood piece to which is the test and protection equipment attached to. The acoustic waves and vibrations may comprise a plurality of different frequencies and optionally also different amplitudes. The frequencies are usually in the audible range, wherein the amplitude might be a relatively low, resulting in an acoustic pressure which is Valley here about. Nevertheless, the acoustic receiver 12 is configured to receive the acoustic waves and vibrations from all three directions. Ask why that and provides such information to the control circuit 14. Control circuit 14 convert that information into a digital signal for communicating the information via the communication interface 15.

The test and protection equipment attached to wood piece in a remote location can be periodically trigger by the control interface 14 for example to obtain periodic measurements every second months. In between these measurements, the control circuit will switch into a low power mode, shutting down the transducer and receiver, respectively to save as much power as possible. In some aspects, element 16a can be a photovoltaic element for recharging of the rechargeable battery 16, thereby extending the lifetime of the battery and its power supply.

FIG. 5 illustrates another embodiment, in which the test and protection equipment 1 is strapped via two flexible rubber bands 19 onto the wood piece here in form of an elongated pole 20. In contrast to the previous embodiment, sensor surface 11 extends over the whole bottom part of casing 10 of test and protection equipment 1. The surface of transducer 13 is attached directly to the plastic material of the sensor surface 11 within the casing 10 to transfer its vibrations preferably without significant attenuation onto the wood piece 20. Likewise, the receiver surface 12b of acoustic receiver 12 is attached to the inner surface of sensor surface 11 within the casing 10. Acoustic transducer 13 and acoustic receiver 12, then protected from possible environmental hazards are connected to a communication interface via a control circuit 14. The control circuit 14 as well as the other elements are supplied by a battery pack 16.

The proposed method and evaluation system utilizes an evaluation unit with a trained machine learning model. The system is able to classify the structural integrity of a wooden object over time and improve the accuracy of its classifications by a variety of techniques. The trained machine learning model can utilize a supervised learning, unsupervised learning or reinforcement learning technique, although other machine learning techniques and approaches are possible.

Referring now back to FIG. 1c and the proposed test and protection device 1. The equipment 1 is attached to the respective poles using a fastener 12′ at a certain height H. These heights H, at which the testing device is attached can be different from pole to pole without the necessity to be placed in a certain size or having them placed all close to the same height. This will allow the installation of the respective testing devices at a later stage, and even under various conditions at which, for example, certain heights are not available. Nevertheless, when using additional sensors like the acoustic transducer as explained further below. Installation at roughly specific locations on the pole is beneficial to improve the measurements.

Furthermore, the installation of testing devices 1 with fastener 12′ at the respective poles occurs at a safe distance away from the actual power line such that installation of the testing devices 1 does not affect the power grid or the supply of power itself. Each testing device 1 comprises a battery for providing power to the respective testing device, rendering of the testing device substantially independent of any other external power source. The battery itself is a rechargeable battery and connected to a small solar panel (not illustrated) directly attached to the testing device. When installing the testing device 1, it is suitable to arrange the solar panel facing the south (or at least towards the sky) to be able to harvest sufficient energy throughout the day and during the seasons in order to power the device and charge the battery.

Each testing device 1 contains an antenna 11 attached thereto, which is also distanced apart from the power line 30. Non antenna may be implemented as a broadband and non-tuned antenna that will pick up EMF signals emitted from the power lines 30 particularly from 50 Hz or 60 Hz onwards. If the bandwidth is not sufficient, several of such antennas can be used, which may also be arranged at various angles to each other to potentially compensate for misalignment to the power line. In some aspect, the fastener 12′ when made of metal can be used as a portion of the antenna.

However, as stated already, a proper alignment to the power line is not required, because the testing device does not measure absolute values but relative changes. The shape of the antenna can therefore vary and may include flat, straight or spiral shaped forms. The antenna is configured to receive any radiation emitted by the power line and forward that received signal to an amplifier and filter amplification and further processing. The principle is as follows. Fluctuations and variations, both short and long term, in the power line either due to changes in its distance and location with regard to the antenna's location are detected by the antenna. Long term variations are the above-mentioned temperature changes, ice on the power line or slowly growing vegetation, which change the surroundings. Short term variations include glitches like corona discharges, any physical damage or lightning. All of these change the electrical behavior (and electro-magnetic behavior) of the power line and lead to a varying radiation characteristic.

The changes are detected by the testing devices attached to the poles. While short term characteristics, like lightning strike or corona discharges, are visible directly in the signal, long term variation require storage of previous measurement results and a comparison thereof. For this purpose, the evaluation unit of the testing device or the central unit contains such storage. In any case, certain short-term and long-term changes are associated with certain events affecting the power line. For example, ice or snow sags the power line due to its additional weight. The sagging is usually towards the antenna. Consequently, the amplitude of the basic 50 Hz frequency signal on the power line will increase in the measured data with shrinking distance between the power line and the antenna.

In another example, the internal temperature changes due to the overall current in the power line or possible losses due to a locally limited higher resistance. The increased temperature sags onto the power line itself, stretching the power line. Vegetation close to the power line may cause small partial discharge and micro shorts to such nearby vegetation. These spikes are usually of high frequency and are identified as Spike shaped noise emissions in the signal. Distinguishing between the different signal changes and the events causing them, enables identification of such events and taking proper measures taken in response thereto.

Yet another aspect is given by the already mentioned partial discharge. Partial discharges in or on the insulator in the power lines are often caused by voids or impurities within the insulation, cracks in the insulation, sharp points on conductors, or uneven interfaces between different insulation materials. During certain weather conditions, snow or ice can accumulate on or close to the insulators, which can also cause a partial discharge. The partial discharge may erode the insulation over time, reducing its insulating capability. This can ultimately lead to breakdown and failure of the insulation, potentially causing equipment failure or power outages.

However, there are several methods to detect partial discharge, all of which can be implemented into a testing device in accordance with the proposed principle. Hence, the proposed principle is not limited to an antenna to detect partial discharge, but may comprise further and different kinds of sensors. In one way, partial discharge may generate ultrasonic waves. Specialized ultrasonic detectors can be used to pin-point the location of the discharge.

As mentioned, the antennas can be used to detect characteristic Electrical pulses caused by the partial discharge. By measuring these pulses, it's possible to detect and locate the discharges. As partial discharge provides HF signals, UHF sensors like specialized antennas can detect the high-frequency electromagnetic waves produced by partial discharge. Some partial discharges produce audible noise. Acoustic sensors can be used to detect these given a specific frequency range.

Once detected, the magnitude and frequency of partial discharge events is quantified. This can help in assessing the severity of the issue and deciding on a course of action. Furthermore, regular monitoring for partial discharge can help detect insulation problems before they lead to equipment failure. This is crucial for preventive and predictive maintenance, ensuring the longevity of equipment, and preventing potential blackouts or power disturbances. Modern partial discharge testing equipment can analyse the pattern, magnitude, and frequency of PD events. This analysis can offer insights into the nature and potential causes of the partial discharge. If partial discharge is detected and deemed significant, corrective actions such as repairing or re-placing the affected insulation may be necessary. Regular partial discharge testing is crucial, especially for aging power equipment, to ensure the health of the equipment and the reliability of the power system. It helps utilities and industries to plan maintenance, reduce unscheduled outages, and avoid potential catastrophic failures. The proposed principle offers such solutions.

For this purpose, the testing device 1 according to FIG. 2 comprises an antenna, which may comprise various shapes and forms as stated above to be able to receive the signals emitted by the power line overhead. Although FIG. 2 only illustrates one single antenna 11, a plurality of different antennas of various sizes, forms and shapes as well as other types of sensors as mentioned above can be attached to the testing device to be able to detect the respective signals in a broader frequency range. However, it has been found that the actual location and position with regard to the power line is not of a large importance and particularly may vary throughout the different testing devices. Nevertheless, any event in the power line can be detected even if the antennas are slightly displaced with regard to each other on the various testing devices due to the relative measurement and evaluation.

The testing device of FIG. 2 further includes a first filter 101 applied on a system board 100, which is connected to the antenna for filtering and suppressing any unwanted frequency bands. The remaining signal is amplified by one or more low noise amplifiers in the frequency band of interest, implemented in an analog-to-digital converter 111. The digitized signal is then converted and is applied to a plurality of different filters. Each filter is configured to process the same signal, individually and separately from each other, providing processed data to a multiple detection algorithms. The filters can have different functionalities, further curves and other characteristics to extract certain information therefrom. For example, one filter may be used to provide a fast Fourier transformation, FFT while another provides a high pass to detect noise portions. The FFT can then be used to detect signals outside the 50 Hz and its harmonics.

In this particular embodiment, each filter is connected to a detection algorithm portion, which forms an evaluation unit in order to detect one or more actual events and distinguish the events from any coincidental signal on the power line as well as to noise on the line itself. The detected signal is then associated with one or more probable events that have a characteristic like the detected and processed signal. In this regard, the respective detection and identification algorithms can be implemented to detect one or more events out of a plurality of possible different relevant events on or in the respective power line. The algorithms can either be embedded by machine learning to reduce the need for central processing. This also reduces the required bandwidth as only the detected event is to be transmitted and not the actual signal of interest. If the bandwidth is sufficiently large, the detected and pre-processed signal may be transmitted to a central unit for further handling and identification. To this extent, a trained machine learning network is usable in a central unit receiving the events from a plurality of testing devices. Hence, the central unit can also be used to correlate events detected by different testing devices. This improves the event identification and probably location thereof within the power grid.

For evaluation of events, the detected events are compared with the respective threshold level. The threshold serves as an indicator to, whether a certain event is to be reported to a central system or not. Certain kinds of events like damaging the power line by a falling branch or tree, a phase short or the like should be reported directly to a main database including the location of the occurrence of such events. This allows to significantly reduce the time for maintenance, as the location of such an event can now be located, and director measures taken.

In the exemplary embodiment, the evaluation unit with its various implemented detection and identification algorithms is coupled to a reporting system comprising a wireless interface. Upon request by the evaluation unit, the wireless interface transmits a respective event message to a central receiver. The event message includes all necessary information about the event, and if possible, portions of the data itself to heave the identified event confirmed. Upon reception of such a signal, further analysis is conducted, and the event stored in a database. Furthermore, the receiver may acknowledge and may also trigger proper measures to be taken. Maintenance is simplified, as the type of event is already known, and spare parts can be collected beforehand, reducing the downtime of the power line. In this regard, the illustrated database herein can be used to provide further statistics on certain events. For example, if certain type of events occurs more frequently in certain areas or during certain times, the database is used to trigger predictive maintenance actions for such areas. For example, in areas in which vegetation grows quicker, certain predictive maintenance operations are triggered faster to prevent possible damages to the power line.

As poles and other support for the power lines are often made of wooden material, they are subject to degradation and other hazards as already mentioned above. Furthermore, bords and particularly woodpecker, may peck on the poles, thereby creating holes, which in turn cat as entry for pest infestation rot and others. Consequently, degradation of the woods may include wood pecking as well and such degradation can be both of physical/mechanical nature or biological nature.

As a result thereof, FIG. 7 illustrates another embodiment, in which the testing device as stated above is amended with additional sensors to obtain information about the possible threats and/or the status of the wooden pole to which the device is attached to. These threats include the above-mentioned degradation by pest, rot and the like, but also woodpecker in the vicinity. Those could choose the pole as a place for pecking, thereby creating damage to the pole. The following embodiment of FIG. 7 tries to cope with this threat by detecting it early on and act accordingly in response thereto.

The test and protection equipment in this embodiment embodies all three functionalities combined. In this embodiment, the wooden workpiece 20 having length L, width W as well as height H is provided. The length L runs along the Z-direction, while the width and height of the respective wood piece 20 extend in the X- and Y-direction, respectively. A testing device box 1 is firmly attached to the outer surface of the wood piece 20. Test and protection device 1 comprises an antenna element 11, a detector unit, an evaluation unit 110 (not shown) and a casing 10, in which an additional transducer element 13 as well as at least one microphone and a loudspeaker are arranged. The transducer element 13 is configured to emit acoustic sound waves directly into the wood piece 20. The element 11′ acts both as microphone and loudspeaker. As a loudspeaker, element 11′ is configured to emit woodpecker sounds stored in a memory of the device 1 into the environment.

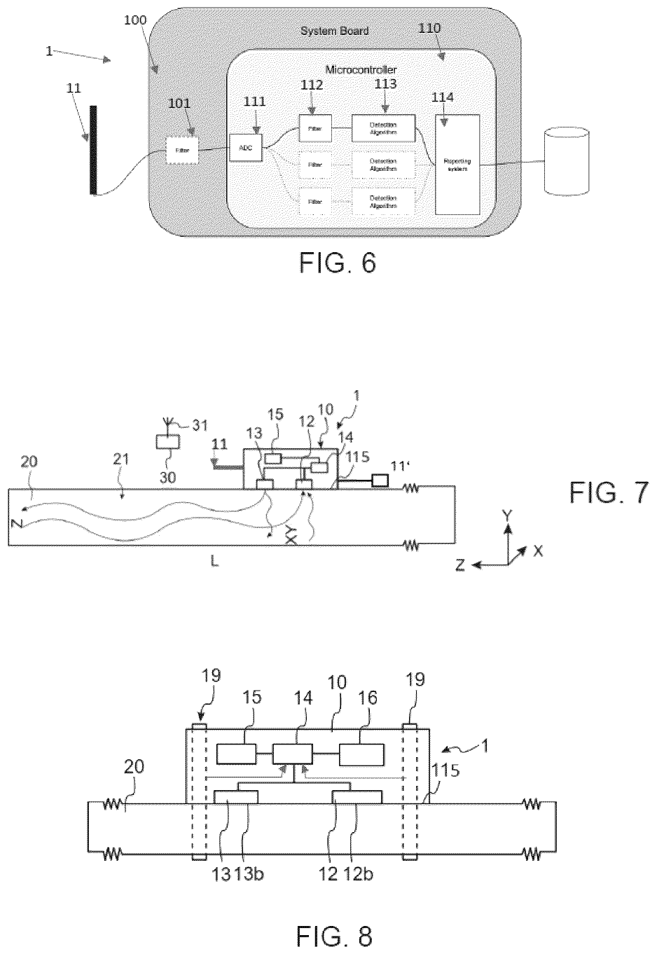

For the purpose of emitting acoustic sound waves directly into the wood piece 20, the transducer 13 is located at the bottom part 15 of casing 1 in direct connection to the surface of wood piece or pole 20. As illustrated in FIGS. 1c and 6, the transducer 13 induces acoustic waves in all three directions X, Y and Z having a dedicated frequency in the audible range that is between 200 Hz and 15 kHz. The audible frequency is adjustable depending on the set-up and other parameters of the workpiece 20.

Testing device 1 further comprises an acoustic receiver 12 in a casing 10 similar to the transducer 13. The acoustic receiver 12 is directly attached to the outer surface of the wood piece 20 configured to receive any acoustic wave propagating on the wood piece's surface. In some instances, the acoustic receiver can also act as a fastener 12′ indicated above. The element 11′ includes a microphone to record environmental sound. The microphone is also connected to a circuit 14. Signals that are recorded by the microphone are processed by circuit 14 to identify potential threads, like the sound of wood pecking and/or the sounds of woodpeckers as such. If such sound is received, the circuit may either communicate via a communication interface 15 with an external station to identify the species. Upon identification of the species, the external station responds back triggering the circuit 14 to play back a certain sound back via element 11′ to deter the bird.

The control circuit 14 in casing 10 is further connected to the acoustic transducer 13 as well as to the acoustic receiver 12 and a communication interface 15. The communication interface 15 is implemented as a wireless communication interface capable of receiving and transmitting data using a wireless network protocol like 3G, 4G and 5G or the derivates therefrom. In very remote locations, the communication interface may utilize a satellite communication network. Consequently, the testing device 1 can be attached to any wood piece 20 in a remote location.

The control circuit 14 periodically receives in operation of the device the EMF signal from the antenna 11 and processes the received signal in accordance with the proposed principle. In addition, the control circuits 14 periodically trigger the transducer to emit one or more acoustic waves of a single or different frequencies into the wood piece 20 as illustrated in FIG. 7. The induced acoustic waves propagate through the wood piece 20 in all three directions and are reflected at least partially at certain interfaces within the wood piece.

In the case of the present embodiment, an indentation or crack 21 is located on the left side of the testing device 1 in the wood piece 20. This indentation will change the reflective or transmissive behavior of the acoustic wave in this direction, resulting in a change of the reflected wave subsequently received by the acoustic receiver 12 in regard to a “healthy wood piece”. The reflected acoustic wave is subsequently received by the acoustic receiver 12 and converted into a respective signal. In this regard, acoustic receiver 12 is configured to receive acoustic waves or vibrations from all three directions individually as indicated and, as such, can generate a different signal therefrom.

Any detected or identified event on the power line as stated above as well as the data from the acoustic receiver 12 are forwarded to the control circuit 14, which subsequently triggers the communication interface 15 to transmit the information to an external evaluation unit 31 with a receiving antenna 31. The evaluation unit makes use of the same communication protocol as interface 15. For example, the evaluation unit 30 is located close to a cloud or another facility providing computational power. The facility establishes a hub for example, to receive and evaluate a plurality of signals from various testing devices at different remote locations.

Periodically or even continuously sound of the environment are recorded by microphone in element 11. Sounds that are recorded by the microphone are processed by circuit 14 to identify potential threads, like the sound of wood pecking and/or the sounds of woodpeckers as such. If such sound is received, the circuit may either communicate via the communication interface 15 with the evaluation unit 30 to identify the species. Upon identification of the species, the external station responds back triggering the circuit 14 to play back a certain sound back via element 11′ to deter the bird.

The externally arranged evaluation unit 30 now utilizes a trained machine learning model to determine the state of the power line, identify possible events affecting the line, and/or determine the state of the wood pole 20 and/or determine possible woodpecker sound or its respective species. These models are usually different and optimized individually and separately to the respective task. Although the exemplary embodiment herein points out some combined measurement of the physical characteristics of the pole and the electrical parameters of the power line transmission, it should be noted that measurements on the power line and events affecting the power line may occur more frequently than measurements on the pole. For example, measurements of the pole may occur once a week, while measurements on the power line may be performed once every half day or so.

Any deviation either in the detected events, a possible woodpecker or in the pole from a normal status or what is to be expected over time is recognized by the trained machine learning model based on prior electrical characteristics of the power line. Hence, even long-term variation can be detected and identified using such models.

Another model is used for identification of different types of degradation, as well as their sizes and locations thereof. For example, the acoustic wave in the Z-direction will be partially reflected at the indentation 21′ indicating a change of the length or deviation in the length of the wood piece towards the left side of the testing device 1. The characteristics are evaluated by the trained machine learning model and provided to the user. Yet another model may be used to detect the species of a woodpecker or any other bird in the vicinity. The type of sound as explained in this application may be used for such a purpose to evaluate the risk for the pole.

In contrast to conventional testing device and methods, the present testing device 1 is located with all elements spaced apart from the power line, but still attached to the pole. This will allow providing a plurality of such test and protection devices onto several wooden objects in a larger area and evaluate the quality of the respective wood pieces in that area, while providing further environmental data and characteristics of power lines nearby. Depending on the nature of the degradation, one can monitor a large are, e.g. of forest, wooden structures and the like without the need of being physically present or measuring and inspecting each wood piece individually.

FIG. 8 illustrates another embodiment, in which the test and protection device 1 is screwed via two metallic rods 19 onto the wood piece, here in the form of an elongated pole 20. The rods 19 also form the antenna, as in the previous embodiments. The antenna is coupled to the control circuit 14 including the microcontroller 110, the filters and the low noise amplifier as illustrated above.

Sensor surface 11 extends over the whole bottom part of casing 10 of test and protection device 1. The surface of transducer 13 is attached directly to the plastic material of the sensor surface 11 within the casing 10 to transfer its vibrations, preferably without significant attenuation, onto the wood piece 20. It is structured in such way to either induce sounds directly into the wood piece or into the environment, i.e. thereby acting as a loudspeaker for example to produce woodpecker deterring sounds.

Likewise, the receiver surface 12b of acoustic receiver 12 is attached to the inner surface of sensor surface 11 within the casing 10. Acoustic transducer 13 and acoustic receiver 12, then protected from possible environmental hazards, are connected to a communication interface via a control circuit 14. The control circuit 14 as well as the other elements are supplied by a battery pack 16 which in turn is charged by a photovoltaic panel (not illustrated).

The proposed method and evaluation system utilizes an evaluation unit with a trained machine learning model. The system is able to classify events either from physical or electrical nature affecting the power line and the structural integrity of a wooden object over time and improve the accuracy of its classifications by a variety of techniques. For the two different types of information, e.g. events on the power line and structural information of the poles. Two or more learning models can be used. However, the general approach for training the models is the same and the outcome in both cases shall be a pool of possible events or pole characteristics associated with certain data types and structures.

The trained machine learning model can utilize a supervised learning, unsupervised learning or reinforcement learning technique, although other machine learning techniques and approaches are possible.

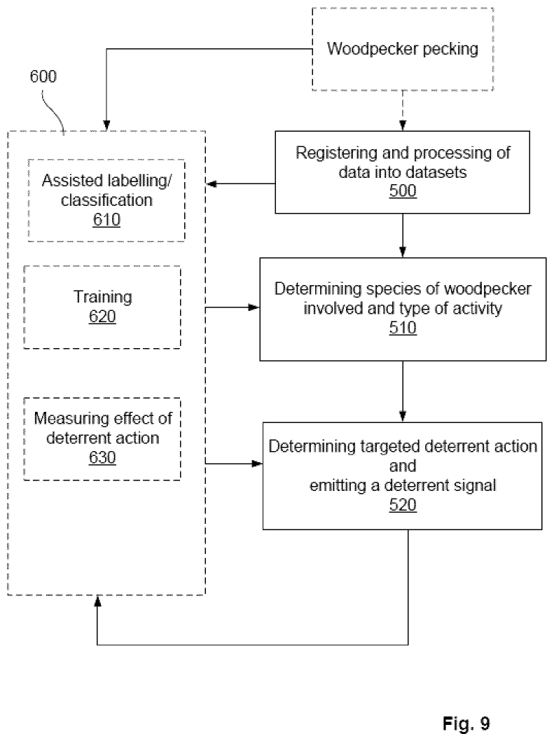

Reference is now made to FIG. 9 showing a flow diagram of a method for acoustic deterrent targeting individual species of woodpeckers 400 according to the proposed which different aspects of the apparatus 100 according to the proposed principle works. It is understood that the method illustrated herein can be implemented in the other embodiments as well and thus combined with a test and protection equipment also configured to detect the status of the pole and/or to detect and identify events on the powerline.

The method according to the proposed principle comprises a step 500 comprising registering woodpecker 400 pecking on a structure 300 to be monitored or associated parts thereof, by the at least one acoustic sensor array 110. The registered acoustic signal data is processed either by processing capacity in the acoustic sensor array 110 or control unit 120, and datasets are stored in the memory 130.

In accordance with one embodiment of the method, step 500 further comprises registering acoustic signal data of pecking that create vibrations propagating in the monitored structure 300 or associated parts. Accordingly, this embodiment will not be directed to measurements into the air, but the pecking as registered in the structure 300 or associated parts. For this purpose one may use the implementations and embodiment also mentioned herein to detect infestation rot, fungal and/or mechanical damage of the pole. In accordance with a further embodiment of the method, step 500 further comprises filtering out soundwaves via the surrounding air that may disturb the acoustic sensor 111 measurements or deteriorate determination of the woodpecker 400 species and/or activity.

The method further comprises a step 510 comprising determining the species of woodpeckers 400 involved and type of activity performed by the involved woodpecker 400, based on comparing the registered acoustic signal data with patterns or signatures unique for each woodpecker 400 species and activity types stored in at least one database in the memory 130. Accordingly, in this manner providing a real-time or near real-time classification of the woodpecker 400 involved, as well as the type of activity performed by the involved woodpecker 400.

The method according to the proposed principle further comprises a step 520 comprising, based on the determined woodpecker 400 species and type of activity, choosing a targeted deterrent action from available actions stored in the same or separate database in the internal or external memory 130. In addition, the step 510 comprises controlling settings of the at least one acoustic deterrent emitter 200 according to the chosen deterrent action to emit a targeted deterrent acoustic signal to deter the identified woodpecker 400 species.

According to a further embodiment of the present invention, the method comprises machine learning steps 600-630. According to one embodiment of the method comprising a machine learning step 610 of classifying the datasets by assistive learning of the acoustic signal data from the at least one sensor array 110 to improve the identification of the labelling/classification of the type of activity performed by the wood-pecker 400 and if it is causing damage to the structure 300 or associated parts, and/or noise. The improvements in the labelling/classifications is used for adapting the settings of the control unit 120, i.e. step 510 of the method above.

The machine learning step 610 comprises determining the type of pecking activity of the involved woodpecker 400 species as well as determining the woodpecker species 400 involved, based on stored patterns or signatures unique for each activity and each woodpecker 400 species in the same or separate database in the internal or external memory 130 together with machine learning rules.

According to one embodiment of the method comprising a machine learning step 620 of training using a set of historical acoustic signal data of woodpeckers 400 pecking and configured to adapt and update its analysis and responses based on new sensor data as it is received. Results of the training is used for adapting the settings of the control unit 120, i.e. step 510 of the method above.

In accordance with a further embodiment of the method according to the present invention, the method comprises a step of reporting to a user of incidents and actions taken. According to one embodiment of method according to the invention, the method comprises transferring the datasets of acoustic signal data to a remote unit for performing machine learning on the remote unit. The remote unit is then transferring the results back to the apparatus 100 for implementation of settings.

The method according to a further embodiment of the proposed principle comprises a method step 530 and/or machine learning step 630 of measuring the effect of deterrent response (activity) and uses the collected data to improve classifications and response (activity) parameters (settings). In accordance with a further embodiment of the present invention, two or more apparatuses 100 are arranged cooperating by means of the wireless communication units 150. In such an embodiment, the results of the machine learning can be distributed to the other apparatuses 100.

According to a further embodiment of the present invention, the apparatus 100 comprises one or remote acoustic deterrent emitters 200, provided with wireless communication units, controllable by the control unit 100 via the wireless communication unit 150. In accordance with a further embodiment of the present invention, the apparatus 100 comprises one or remote acoustic sensor arrays 110, provided with wireless communication units, enabling extended registration of acoustic signal data of pecking from woodpeckers on the structure 300 or associated parts via the wireless communication unit 150.

The above-described embodiment may be combined to form modified embodiments within the scope of the attached claims. Accordingly, by the proposed principle is provided an apparatus 100 and method that enables real-time or near real-time monitoring and control of woodpecker damage and noise. By the proposed principle is provided an apparatus and method enabling early detection and effective deterrent measures to be taken. The proposed principle thus provides a solution capable of protecting structures 300 and associated parts from damage, reducing the risk of costly repairs or replacements and prevent the noise created from the pecking of woodpeckers.

By the proposed principle is enabled an automatic and remote solution, that is plain to install and of low costs. The proposed principle further enables a solution enabling the identification of the woodpecker species, as well as being able to differ between the type of pecking activity and using this information to tailor the response and thus enable a targeted response to deter the identified woodpecker species. Further, due to the machine learning features, the proposed principle enables a solution that is able to self-improve by measuring the results of the classifications models accuracy and the response from the deterrent strategy used.

The proposed principle may also be used on other birds or animals to deter other unwanted behavior from animals or birds, if the activity has unique patterns or signatures that can be detected by the at last one sensor array and accompanied with a targeted deterrent response. In other applications, also deterrent means, such as light, vibration, can be used instead of or in combination with the at least one acoustic deterrent emitter.

In some instances, a plurality of test and protection equipment is spread throughout a larger area along the respective power lines, configured to detect and identify one or more of the above events, like electrical parameters of the grid structure, events on the pole and possible other threats like the woodpecker. For communication with a respective central transceiver distanced far away from the power lines and the individual test and protection devices, such test and protection devices are configured to communicate at certain time slots throughout the day. Communication is done by relaying the messages along the test devices installed on the poles of the power line toward a central receiver. Hence, a certain event messages relate from the test and protection device via a plurality of devices towards the final central transceiver. This may also provide a possibility to communicate in areas which are not covered by a telecommunication standard, like 3G, 4G or 5G.

In other aspects, the transceiver may transmit one or more control messages triggering the test and protection devices to conduct a measurement. Hence, the testing devices may not operate continuously, but take measurements only in response to a command by a central control device. Alternatively or in addition, the test and protection devices may periodically check and measure the electrical characteristics of the power line in order to reduce the overall power consumption.

FIG. 10 illustrates a signal, which certain events on the overhead power line are detectable based on the respective detection. The curve illustrates the 50 Hz main frequency on the power line after certain processing, in which the AC value resulting from the power line has been filtered out. However, the P and T dots indicate the respective peaks and zero crossing points of such signals, occurring at approximately every 20 ms. The representation may help to identify glitches in the peaks and crossings, as well as differences in the respective amplitudes or peaks between the 20 ms period. As visible from FIG. 10, certain events may cause significant peaks and drops in the overall signal, indicating a certain event on the power line. Such events affect the power line and result of duration in the overall emitted signal via the power line. Consequently, the EMF signal is received by the antenna, filtered and amplified to further being processed and evaluated.

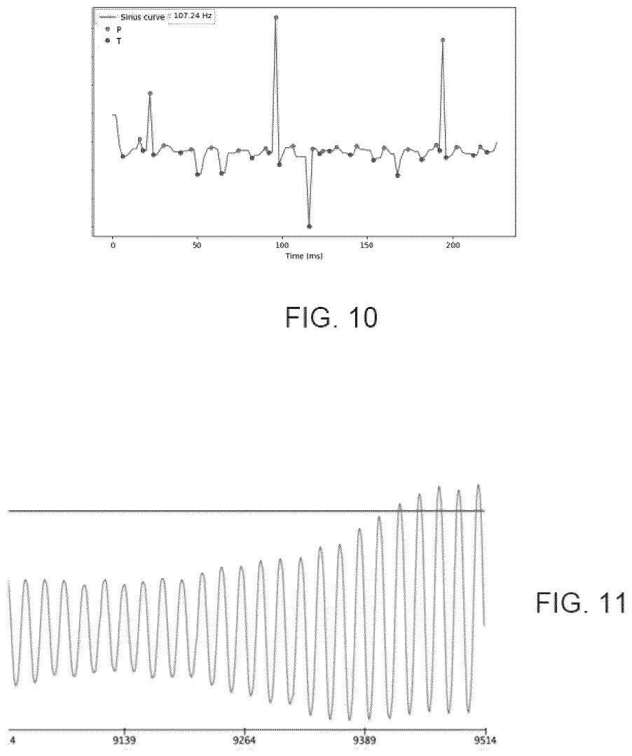

FIG. 11 illustrates the overall amplitude time diagram including a processed AC value of the main frequency at 50 Hz of the main power line signal. By changing the distance of the power line to the antenna, for example due to weight on the cable (ice, snow), storms or other hazardous events on the power line, the distance is changing, resulting in change of the amplitude over time. The slope (that is, the frequency or period of the amplitude modulation) can provide information about the event. For example, a slow change may indicate accumulation of ice on the power line, while a quick transition from a small amplitude to a large one (or vice versa) may indicate a quick change, e.g. by a fallen branch, mechanical resonance and the like. Hence, by evaluating the amplitude, the duration of the change as well as other parameters, sagging or shrinking of the power line can be detected early on and preferably prior to causing further damages.

Another example is presented in FIG. 12, in which peaks are observed exceeding a certain threshold level. Such peaks, appearing randomly, may indicate a short line to ground, for example by branches hitting the power line due to wind or storm. Hence, a team can be assembled to cut back the vegetation at the respective area. Such events can be detected by several antennas and possible a plurality of testing devices. This may help to locate the actual event in a certain area.

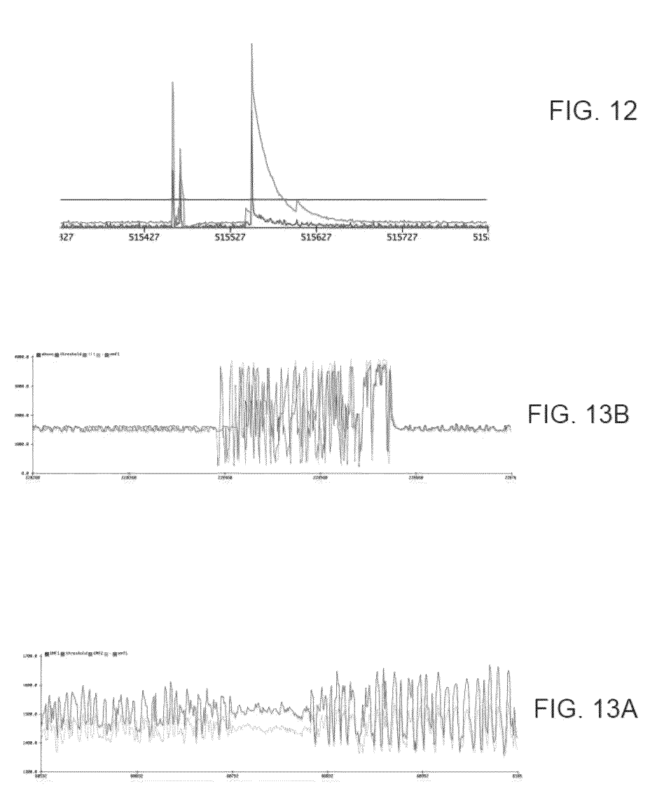

FIGS. 13A and 13B illustrate further examples of noise and other more or less random signal portions detected by the antenna and occurring on the power line. Based on its characteristics, the signal is associated with certain events affecting the electrical characteristics of the power line in the same way as observed. By evaluating the occurrence and certain signal parameters and characteristics, one can identify the type of event as well as the location of the event on the power line itself. If such an event is either of a certain type or exceeds a certain threshold, further methods like informing the provider of the power line can be taken by the testing equipment.

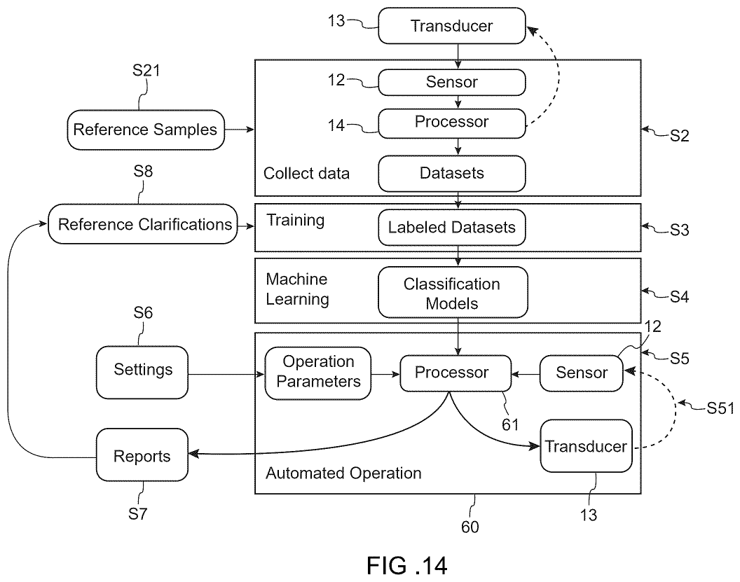

FIG. 14 illustrates various steps of an initial training and a subsequent training of a model to further improve the identification and location detection of possible degradations in the wood piece. The present model and the training process can also be applied to identify the woodpecker species or detect and identify certain events on a power line as illustrated further below.

A plurality of reference samples S21 are applied to collect data in step S2. Steps S2 uses a transducer, a sensor as well as a processor to provide a plurality of data sets. This step resembles the test and protecting equipment 1 and the collection of data by the test equipment. Collecting data is not limited to an initial training but can be an ongoing process as depicted herein to continuously improve the model. The processor 14 triggers the transducer 13 to induce a plurality of acoustic waves within the reference samples S21 and collects a plurality of data sets using the sensor 12. These data sets are then forwarded to the machine learning model for training as depicted in step S3. In a similar fashion, one may record a plurality of different sounds from woodpeckers or other noises in the environment and forwarded those to a respective machine learning model for training as depicted in step S3.

The data sets are connected and associated with a ground truth labelled as a reference classification S8. The reference classifications include all kind of characteristics to obtain correlations thereof to the collected data, including but not limited to the geometry of the respective reference samples, the type of wood, the type of degradations as well as the location and size in relation to the test equipment. In other aspects it labels the respective bird species as well as the sound type as outlined above. The machine learning model utilizes one or more of the above-mentioned techniques like supervised or reinforcement learning to provide a plurality of label data sets and subsequently classifications of the possible degradations in step S4.

The process of using reference samples with their respective classifications and training the machine learning model in step S2, S3, and S4 is continued and repeated until the desired feature recognition and detection probability is achieved. In a subsequent step the evaluation process is then fully automated as illustrated in step S5. The trained machine learning model is utilized by an evaluation unit 60 having a process server 61, which is fed with information by sensor 12 in response to the acoustic vibrations triggered by transducer 13. Further parameters like the geometry of the respective wood piece, the shape selected from a potential list of possible shapes are also input as operational parameters selected by a user in step S6 from a plurality of possible settings. The evaluation unit 60 provides a report in step S7, indicating at least one of the position and the size of the possible degradation. Based on result of a subsequent visual inspection, these reports can be used as input for further reference classification and ground truth to improve the machine learning model in steps S3 and S4, respectively.

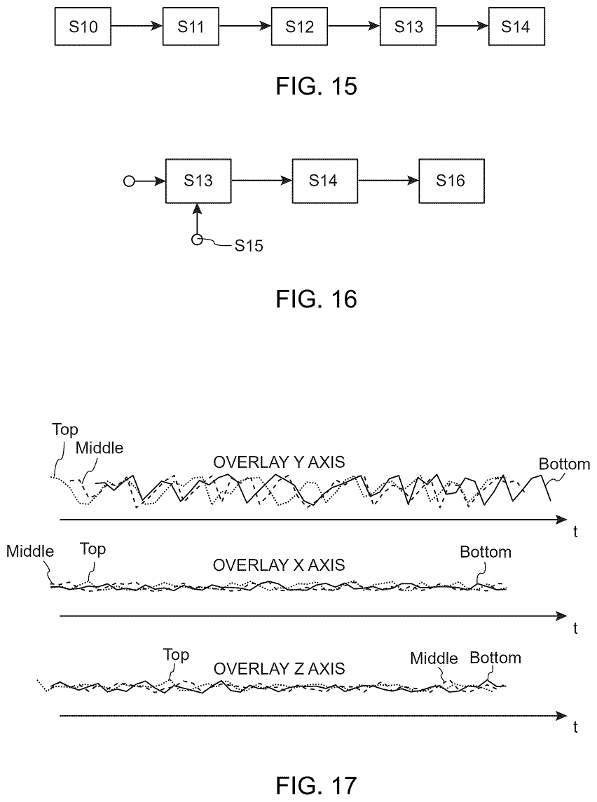

FIG. 14 provides an overview of the aspects in combination with the test equipment, the evaluation unit as well as the machine learning model proposed in the present application. FIG. 15 shows the steps of a method for evaluating the quality of an elongated wood piece in particular a wood plank or a pole, in which the machine learning model has already been trained in accordance with the proposed principle explained earlier on. At least one three-dimensional acoustic wave or vibration with at least one audible frequency is induced in step S10 into the wood piece along one of its elongated sides. In this regard, the elongated side is used as the test equipment configured to induce such acoustic wave is probably attached along the elongated side. However, the proposed method is not limited to such side, but the acoustic wave and vibration can also be induced on any of the other sides as long as the acoustic wave is capable of propagating through the wood piece in all three dimensions.

In a subsequent step S11, the acoustic waves or vibrations partially reflected within the wood piece for example at certain interfaces are obtained and detected. The detection occurs at approximately the same location or spot, at which the waves and vibration are induced into the wood piece. More particularly, the detection of the acoustic waves reflected within the wood piece occurs at a location close to the location of the wave induction into the wood piece. Furthermore, a trained machine learning model is provided in step S12. The trained machine learning model is indicated in FIG. 14 and is trained to identify at least one of the location and size of the degradation within the wood piece in response to the acoustic waves over vibrations. Alternatively or additionally the model is trained to define various species of woodpecker and also the type of sound the woodpecker is making in order to identify the potential threat and risk to the pole.

In accordance with the proposed principle, the measurement, that is the inducing and obtaining the acoustic waves, is conducted at a location remotely from the evaluation unit and the machine learning model. This will allow to centralize the results and the evaluation of the respective measurements and render them independently from the location at which the measurements are taken. The expression measurement in this regard refers to inducing and obtaining acoustic waves.

The trained machine learning model will then identify a position and or size of a possible degradation within the wood piece. Such information can be passed on to the user or otherwise be used to trigger an alert for a more detailed individual inspection. In some aspects, the trained machine learning model may require a further input to improve its probability for correct evaluation and determination of the quality state.

FIG. 16 in this regard illustrates a further embodiment. The trained machine learning model will here receive a plurality of further information related to the geometry of the wood piece, the relative position of the test equipment on the wood piece as well as the type thereof. These and other parameters are fed into the trained machine learning model in step S15. Furthermore, and not illustrated herein, the test equipment can provide environmental data like humidity, temperature and air pressure and the like to the trained machine learning model to further improve the evaluation. The trained machine learning model utilizes this additional information together with the measurement data to obtain the state of degradation and potentially a possible location of a biological or physical damage of the wood piece. The evaluation result is then used to provide real-time alerts in step S16 to a user or a controller system if the structural changes are above a certain threshold to trigger prompt and appropriate action. This action may include a visual and manual inspection of the wooden object in question.

The same FIG. 14 can also be used to illustrate steps of an initial training and a subsequent training of such a model to further improve the identification and location detection of possible event on the overhead power line.

A plurality of reference samples S21 (e.g. events and their respective characteristics power line signals are applied to collect data in step S2. They can be artificially generated (e.g. simulated) or real live data for which the event associated with it is known.

Step S2 uses the antenna as a sensor, as well as a processor, to provide a plurality of data sets. These data sets are then forwarded to the machine learning model for training, as depicted in step S3.

The data sets are connected and associated with a ground truth labelled as a reference classification S8. The reference classifications include all kinds of characteristics to obtain correlations thereof to the collected data. This includes results on different filtering, phase and amplitude information of the power line signal, noise level and its frequency dependent occurrence and so forth. For training a model on the quality and degradation of the wood, it may include the geometry of the respective reference samples, the type of wood, the type of degradation as well as the location and size in relation to the test equipment. The machine learning model utilizes one or more of the above-mentioned techniques to provide a plurality of label data sets and subsequently classifications of the possible events in step S4.

The process of using reference samples with their respective classifications and training the machine learning model in step S2, S3, and S4 is continued and repeated until the desired feature recognition and detection probability is achieved. In a subsequent step, the evaluation process is then fully automated, as illustrated in step S5. The trained machine learning model is utilized by an evaluation unit 60 having a process server 61, which is fed with information either by the antenna and sensors in the testing devices or by the signals provides by the testing devices (in case the training model is located at a central unit). Further parameters like the geometry of the respective pole, general weather conditions. Previous events, information on the pole's quality can be input as operational parameters selected by a user in step S6 from a plurality of possible settings. The evaluation unit 60 provides a report in step S7, depending on the application.

FIG. 19 shows the steps of a method for identifying an event on a power line, in which the machine learning model has already been trained in accordance with the proposed principle explained earlier on. An EMF signal is received by an antenna in step S10. In a subsequent step S11, the received signal is filtered and amplified and subsequently digitized. The digitized signal is then filtered by various means and pre-processed to detect one or more possible events occurring or affecting the power line. Furthermore, a trained machine learning model is provided in step S12. The trained machine learning model is indicated in FIG. 9 and is trained to identify a plurality of possible events affecting the power line.

In accordance with the proposed principle, the measurement, which is receiving and detecting possible events, is conducted at a location remotely from the evaluation unit and the machine learning model. This will allow centralizing the results and the evaluation of the respective measurements and render them independently of the location at which the measurements are taken. The expression “measurement” in this regard refers to the reception of EMF signals and the detection of possible events.

The detected events are combined with respective samples for further analysis in step S13 and transmitted via the air interface to the central unit and the trained network. Subsequent analysis is done at the central unit, including further correlation with events also reported from nearby testing devices. Then the trained network models trigger a report in step S14 identifying the event and recommending certain actions thereupon.

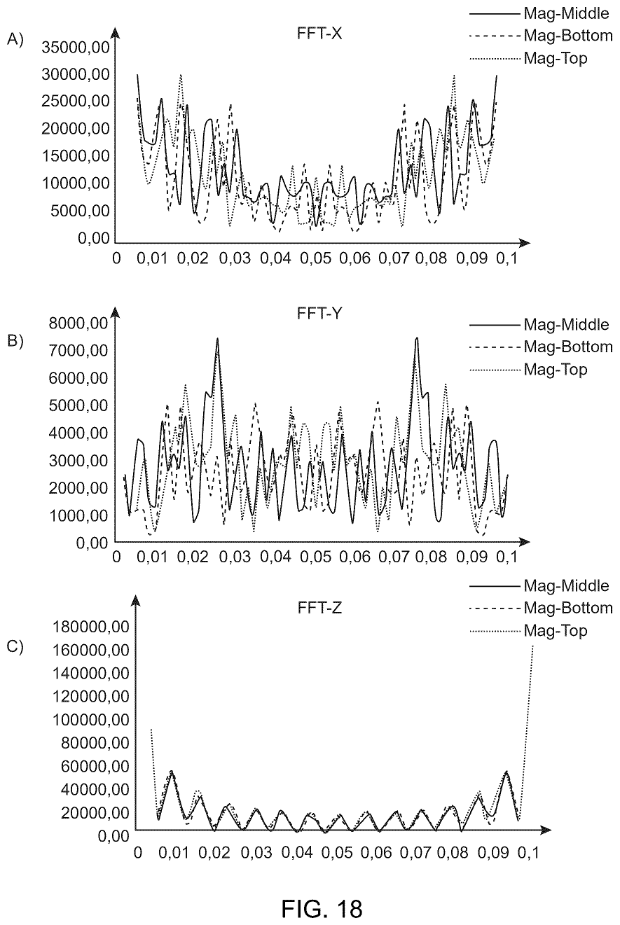

FIG. 17, as well as FIG. 18A to 18C illustrate some measurement results on a wooden pole in accordance with the proposed principle. FIG. 17 illustrates three diagrams of an amplitude signal of reflected acoustic waves in X, Y, and Z-direction over time. The three different curves show the respective measured signals in X, Y and Z-direction with a simulated degradation of the elongated wood piece located at the bottom part (Bottom), the top part (TOP) as well as in the middle part (Middle).

FIGS. 18A to 18C show the respective Fast Fourier Transform (FFT) information of the samples in the respective X, Y and Z-direction. As illustrated in the FIGS. 18A and 18B, the deviation in X and Y direction between the respective frequency components with a simulated degradation in the middle the bottom and top part is remarkable and is used for training a respective machine learning model. In contrast, thereto, there is almost no frequency deviation in the Z-direction. The frequency spectrum in FIG. 18, as well as the signal amplitude over time illustrated in FIG. 17 prove that degradation at different locations relative to measurement point results in signal deviations that can be measured and are characteristic for a plurality of wood pieces and different damages.

The overall three different ideas make use of a mobile and self-sustainable device that is attached to a pole spaced apart from the actual powerline. Still the test and protection device in accordance with the proposed principle offers to detect and determine possible effects on the powerline, including some electrical parameters, like load on the line and the like as well as possible threats or dangers thereto. This may include not only branches close to the powerline, snow on the line or excessive heat during summer times, but also any degradation of the rod and possible threats due to animals like woodpeckers. The device can deter such woodpeckers but also allows to identify those possible threats early on before negatively affecting the grid. Consequently predictive maintenance routines can be established, and animals deterred to avoid potential hazards. It should be noted in this regard, that the various aspects can be combined differently to provide a device that offers each of the proposed ideas herein either separately or in combination with one or more of the other ideas. Communication interfaces, circuitries, memory power supply and even sensors can be shared to some extent making the proposed test and protection equipment a versatile tool for monitoring overhead power grid structures.

The following items include several aspects including test and protection devices, evaluation systems and method in accordance with some aspects of the proposed principle:

1. Test and protection device (100) for acoustic deterrent targeting individual species of woodpeckers (400) arranged on or near a structure (300) to be monitored, wherein the test and protection device (100) comprises at least one sensor array (110) comprising a plurality of acoustic sensors (111), a control unit (120) and at least one acoustic deterrent emitter (200), wherein the sensor array (110) is configured to register acoustic signal data of pecking from woodpeckers on the structure (300) or associated parts,
wherein the test and protection device (100) comprises a control unit (120) configured, by comprising means and/or software, to
determine the species of woodpeckers (400) involved based comparing the registered acoustic signal data with patterns or signatures unique for each woodpecker (400) species stored in a database in an internal or external memory (130) of the test and protection device (100),
determine the type of activity of the involved woodpecker (400) based comparing the registered acoustic signal data with patterns or signatures unique for each type of activity stored in the same or different database in the internal or external memory (130) of the test and protection device (100),
based on the determined woodpecker (400) species and type of activity, chose a targeted deterrent action from available deterrent actions stored in the same or separate database in the internal or external memory (130) of the test and protection device (100),
controlling settings of the at least one acoustic deterrent emitter (200) according to the chosen deterrent action to emit a targeted deterrent acoustic signal to deter the identified wood-pecker (400) species.

2. Test and protection device (100) according to item 1, wherein the at acoustic sensors (111) of the at least one sensor array (110) are configured to register acoustic signal data of pecking that create vibrations propagating in the monitored structure (300) or associated parts.

3. Test and protection device (100) according to item 1, wherein the acoustic sensors (111) and/or control unit (120) is configured, by comprising means and/or software, to filter out soundwaves via the surrounding air that may disturb the acoustic sensor (111) measurements or deteriorate determination of the woodpecker (400) species and/or activity.

4. test and protection device (100) according to any of the preceding items, wherein comprising a separate machine learning module (140) configured, by comprising means and/or software, or the control unit (120) is configured, by comprising means and/or software, to perform machine learning, configured to:
classify the datasets by assistive learning of the acoustic signal data from the at least one sensor array (110) to identify the improve the labelling/classification of the type of activity performed by the woodpecker (400) and if it is causing damage to the structure (300) or associated parts, and/or noise,
determine the type of pecking activity of the involved woodpecker (400) species based on stored patterns or signatures unique for each activity in the same or separate database in the internal or external memory (130) of the test and protection device (100),
determine the woodpecker (400) species involved based on stored patterns or signatures unique for each woodpecker (400) species in the same or separate database in the memory (130) of the test and protection device (100), and/or
train using a set of historical acoustic signal data of woodpeckers (400) pecking and configured to adapt and update its analysis and responses based on new sensor data as it is received.

5. Test and protection device (100) according to any preceding item, wherein the at least one acoustic deterrent emitter (200) is arranged on or near the monitored structure (300) and configured, by comprising at least one transducer or loudspeaker, emitting a deterrent signal in the form of natural sounds tailored to deter the identified woodpecker (400) species from causing further activity.

6. Test and protection device (100) according to item 5, wherein the at least one acoustic deterrent emitter (200) is activated based on the output of the separate machine learning module (140) or control unit (110), and is configured to be adjusted or disabled as needed.

7. Test and protection device (100) according to any preceding item, wherein the test and protection device (100) is configured for real-time or near real-time monitoring and deterrent of woodpecker (400) damage and noise.

8. Method acoustic deterrent targeting individual species of woodpeckers (400), wherein the method comprises:
registering woodpecker (400) pecking on a structure (300) to be monitored or associated parts thereof, by the at least one acoustic sensor array 110,
determining the species of woodpeckers (400) involved and activity type of the involved woodpecker (400) species, based on comparing the registered acoustic signal data with patterns or signatures unique for each woodpecker species and activity type stored in at least one database,
based on the determined woodpecker (400) species and type of activity, choosing a targeted deterrent action from available actions stored in the same or separate database, and
controlling settings of at least one acoustic deterrent emitter (200) according to the chosen deterrent action to emit a targeted deterrent acoustic signal to deter the identified woodpecker (400) species.

9. Method according to item 8, wherein the method comprising registering acoustic signal data of pecking that create vibrations propagating in the monitored structure (300) or associated parts.

10. Method according to item 8, wherein the method further comprising filtering out soundwaves via the surrounding air that may disturb the acoustic sensor (111) measurements or deteriorate determination of the woodpecker (400) species and/or activity.

11. Method according to any of the preceding items 8 to 10, wherein the method further comprising performing machine learning, comprising:
classifying the datasets by assistive learning of the acoustic signal data from the at least one sensor array (110) to identify the improve the labelling/classification of the type of activity performed by the woodpecker (400) and if it is causing damage to the structure (300) or associated parts, and/or noise,
determining the type of pecking activity of the involved wood-pecker (400) species based on stored patterns or signatures unique for each activity in the same or separate database,
determining the woodpecker (400) species involved based on stored patterns or signatures unique for each woodpecker (400) species in the same or separate database, and/or
training using a set of historical acoustic signal data of woodpeckers (400) pecking and configured to adapt and update its analysis and responses based on new sensor data as it is received.

12. Method according to item 11, wherein updating the settings of a control unit (120) controlling the at least one acoustic deterrent emitter (200) with updated settings from the machine learning steps.

13. Test and protection device for evaluating the quality of a wood piece, in particularly a pole, comprising:
a casing having a sensor surface, said sensor surface configured to be attached to a wood piece;
an acoustic transducer arranged in the casing and configured to generate one or more audible sound waves, said acoustic transducer being in operative connection with the sensor surface such to induce a generated audible sound wave into the wood piece attached thereto;
an acoustic receiver arranged in the casing and in operative connection with the sensor surface, said acoustic receiver configured to detect sound signals, wherein the sound signals comprise portions of the induced sound waves reflected at interfaces of the wood piece;
a communication interface arranged in the casing and connected to the acoustic receiver and configured to transmit values associated with the sound signals detected by the acoustic receiver to an evaluation unit located outside the casing. 14. The test and protection device according to item 13, wherein the sensor surface comprises a curvature configured to cling to the wood piece, and optionally comprises one of:
a flexible material, in particular plastics or rubber;
a material that is different of a material of the casing not being part of the sensor surface.

15. The test and protection device according to any of the preceding items, wherein an emission surface of the acoustic transducer forms a portion of the sensor surface or is directly attached thereto; and/or
wherein a detector surface of the acoustic receiver forms a portion of the sensor surface or is directly attached thereto.

16. The test and protection device according to any of the preceding items, further comprising a control circuit in operative connection with the acoustic transducer and the acoustic receiver and configured
to periodically trigger the acoustic transducer to generate the one or more audible sound waves; and/or
trigger the acoustic transducer to generate the one or more audible sound waves in response to a command received by the communication interface;
trigger the acoustic transducer to generate a pocking sound resembling wood pecking of a woodpecker species.

17. The test and protection device according to any of the preceding items, wherein the acoustic transducer is configured to generate a plurality of sound signals subsequently at different frequencies; and/or generate a plurality of sound signals at different frequencies at once.

18. The test and protection device according to any of the preceding items,
wherein the acoustic receiver is configured to detect reflections from induced sound waves from three distinct directions.

19. The test and protection device according to any of the preceding items, wherein the acoustic transducer and the acoustic receiver are located on the same plane substantially parallel to the sensor surface; and/or are spaced apart from each other by a distance between the range of 2 cm and 25 cm.

20. Evaluation system for evaluating the quality of a wood piece, in particularly a pole, comprising:
the test and protection device according to any of the preceding items;
an evaluation unit configured to communicate, in particularly wirelessly with the test and protection device and further configured by use of a trained deep learning model fed with the transmitted values to locate at least one of position and strength of a possible degradation in the wood piece.

21. The evaluation system according to item 20, wherein the evaluation unit is configured to receive at least one of the types of wood piece, its shape (based on a list of role model shapes), its geometry (i.e. size, length, width and the like) and the position of the test and protection device on the wood piece as input, particularly as user input for the trained deep learning model.

22. The evaluation system according to item 20 or 21, wherein the degradation comprises at least one of:
Ruptures;
Cuts;
notches or indentation;
rot ;
Wood pecking; and
fungal infestation.

23. Method for evaluating the quality of an elongated wood piece, in particularly a pole, comprising:
Inducing at least one, in particular three-dimensional, acoustic wave or vibration of at least one audible frequency into the wood piece along one of its elongated sides;
Obtaining acoustic waves or vibrations reflected within the wood piece at a location along one of its elongated sides;
Providing a machine learning model trained to identify at least one of location and size of a degradation within the wood piece in response to acoustic waves or vibrations;
Transmitting the obtained acoustic waves or vibrations as input to the trained machine learning model;
Identifying by the trained machine learning model a position and/or a size of a possible degradation within the wood piece.

25. Method according to item 24, wherein the possible degradation comprises at least one of:
Ruptures;
Cuts;

Notches or Indentation;
Rot;
Wooed pecking; and
Fungal infestation.

26. Method according to any of items 24 to 25, wherein a location for the steps of inducing the acoustic waves or vibrations and obtaining the acoustic waves or vibrations are on the same plane substantially parallel an elongated side of the wood piece; and/or are spaced apart from each other by a distance between the range of 2 cm and 25 cm.

27. Method according to any of items 24 to 26, wherein the step of inducing acoustic waves or vibrations into the wood piece comprises one of:
generating a plurality of acoustic waves or vibrations subsequently at different frequencies;
generating a plurality of acoustic waves or vibrations at different frequencies at once;
generating plurality of acoustic waves or vibrations with a frequency chirp;
generating a pocking sound resembling wood pecking of a woodpecker species;

28. Method according to any of items 24 to 27, wherein the step of inducing at least one acoustic wave or vibration comprises:
periodically inducing at least one sound wave or vibration with a periodicity between 1 week and 3 months; and/or
inducing at least one acoustic wave or vibration in response to

29. Method according to any of items 24 to 27, wherein the step of identifying by the trained machine learning model comprises the step of:
Obtaining user input related to at least one of:
   a type of wood in the wood piece;
   a geometry of the wood piece;
   a position on the wood piece at which the steps of inducing acoustic wave and vibrations and/or obtaining acoustic waves take place.

30. Test and protection device for contactless detection of events on a power line, in particular an overhead power line, comprising:
a housing having a support adapted to be permanently attached to a pole;
an antenna element spaced apart from the power line and adapted to detect electromagnetic radiation emitted by the power line;
a detection unit arranged in the housing and connected to the antenna element, which is configured to detect a in particular, relative change in the emitted electromagnetic radiation;
an evaluation unit arranged in the housing, which is configured to provide information about a detected event acting on the power line in response to the detected temporal and relative change;
a communication interface arranged in the housing, which is connected to the evaluation unit and configured to wirelessly transmit the detected temporal and relative change corresponding to an event or said information by the evaluation unit to an evaluation station located outside the housing.

31. The test and protection device according to item 30, wherein the evaluation unit is configured to identify an event acting on the power line in response to a detected temporal and relative change and the communication interface is configured to transmit the identified event.

32. The test and protection device according to item 30 or 31, wherein the evaluation unit is adapted to identify at least one of the following events:
a mechanical load isolated from the earth, in particular snow or ice on the power line;
corona discharges due to deterioration of the insulators;
a change in the length of the power line between two holding points of the power line, in particularly caused by temperature or a change in temperature;
a mechanical resonance in the power line, particularly induced by wind;
an at least partially conductive connection, in particular in the form of vegetation close to the power line, which causes a corona or sporadic micro-shorts;
current flashovers or discharges to an at least partially conductive connection near the power line;
a short-circuit to earth, in particular due to vegetation coming into contact with the power line;
a phase short to an adjacent power line;
a lightning strike to the power line or to an element connected to the power line, in particular a pole.

33. The test and protection device according to any one of the preceding items, wherein the detection unit comprises an amplifier and an analog-to-digital converter connected thereto with at least one digital filter connected downstream, the digital filter having in particular one of the following types and/or functions:
finite impulse response, FIR;
averaging filter or moving average filter;
infinite impulse response, IIR;
Fast Fourier Transform filter, FFT;
Notch filter;
bandpass filter; or
low-pass or high-pass filter.

34. The test and protection device according to any one of the preceding items, wherein the antenna element comprises one of a flat shape, an elongated shape, and a spiral shape and is arranged below the power line, in particular at a distance of at least 1 meter.

35. The test and protection device according to any one of the preceding items, further comprising:
an, in particular rechargeable, energy storage, which is connected to the detection unit, the evaluation unit and the communication interface for supplying those;
optionally, a solar panel attached to the housing for charging the energy storage device.

36. The test and protection device according to one of the preceding items, further comprising:
an accelerometer for detecting a mechanical event that triggers movement of the housing above a threshold acceleration or threshold velocity.

37. The test and protection device according to any one of the preceding items, further comprising:
an acoustic transducer arranged in the housing and configured to induce one or more audible acoustic waves into a portion of the pole, in particular a wooden pole, said portion in connection with the housing;
an acoustic receiver disposed in the housing configured to detect acoustic signals from the portion of the pole, the acoustic signals comprising portions of the induced acoustic waves reflected at interfaces of the pole.

38. The test and protection device according to item 37, wherein the communication interface is arranged to communicate information derived from the sound signals detected by the acoustic receiver to an evaluation unit located outside the housing.

39. The test and protection device according to any one of the preceding items, which
is further arranged to activate the detection unit at predetermined, in particular periodic, times; and/or-is further arranged to trigger the acoustic transducer periodically to generate the one or more audible acoustic waves; and/or
further adapted to activate the detection unit and/or the acoustic transducer in response to a command received from the communication interface.

40. Evaluation system for evaluating events on a power line, in particular an overhead power line, comprising:
at least one test and protection device according to any one of the preceding claims, each test and protection device attached to a respective pole of the power line;
an evaluation station configured to communicate, in particular wirelessly, with the test and protection device, and further configured to identify the event using a trained deep-learning model to which the detected temporal and relative change or the information about the detected event is applied.

41. The evaluation system of item 40, wherein the evaluation station is configured to locate, using a trained machine learning model, at least a position and a severity of possible damage to the pole based on information derived from the acoustic signals detected by the acoustic receiver.

42. The evaluation system according to item 40 or 41, wherein the evaluation station is configured to identify at least one of the following events:
a mechanical load isolated from the earth, in particular snow or ice on the power line;
corona discharges due to deterioration of the insulators;
a change in the length of the power line between two holding points of the power line, in particularly caused by temperature or a change in temperature;
a mechanical resonance in the power line, particularly induced by wind;
an at least partially conductive connection, in particular in the form of vegetation close to the power line, which causes a corona or sporadic micro-shorts;
current flashovers or discharges to an at least partially conductive connection near the power line;
a short-circuit to earth, in particular due to vegetation coming into contact with the power line;
a phase short to an adjacent power line;
a lightning strike to the power line or to an element connected to the power line, in particular a pole; and
a deterioration of the pole to which the test and protection device is attached, in particular by one of fractures, cuts, notches or depressions, indentations, rot and fungal infestation.

43. Method for Identifying One or More Events Affecting a Power

line in a remote environment, comprising the steps of:
receiving,—by an antenna—an EMF signal from a nearby power line;
digitizing an amplified signal thereof;
filtering the digitized signals;
detecting at least one event on the power line using one or more algorithms;
identifying using a trained network model at least one or more event in response to the detected event.

44. Method according to item 43, wherein the at least one or more identified events comprise
a mechanical load isolated from the earth, in particular snow or ice on the power line;
a change in the length of the power line between two holding points of the power line, in particularly caused by temperature or a change in temperature;
corona discharges due to deterioration of the insulators;
a mechanical resonance in the power line, particularly induced by wind;
an at least partially conductive connection, in particular in the form of vegetation close to the power line, which causes a corona or sporadic micro-shorts;
current flashovers or discharges to an at least partially conductive connection near the power line;
a short-circuit to earth, in particular due to vegetation coming into contact with the power line;
a phase short to an adjacent power line;
a lightning strike to the power line or to an element connected to the power line, in particular a pole; and
a deterioration of the pole to which the test and protection device is attached, in particular by one of fractures, cuts, notches or depressions, indentations, rot and fungal infestation.

45. Method according to any of items 43 to 44, wherein the event is identified using several detected events that are correlated with each other, particularly detected events that originate from EMF signals received by different antennas.

46. Method according to any of items 43 to 45, further comprising:
detecting at least one parameter of a wooden workpiece to which the antenna receiving the signal is attached to using one or more acoustic waves through said wood piece;-obtaining degradation information therefrom.

47. Method According to Any of Items 43 to 46, Further Comprising:
transmitting a detected event to a remote central unit; and/or—transmitting the at least one detected parameter to the remote central unit.

1. A test and protection device, comprising:
a housing having a support adapted to be permanently attached to a pole;
an antenna element spaced apart from the power line and adapted to detect electromagnetic radiation emitted by the power line;
a detection unit arranged in the housing and connected to the antenna element, which is configured to detect a relative change in the emitted electromagnetic radiation; and
an acoustic sensor and at least one acoustic deterrent emitter, wherein the acoustic sensor is configured to register acoustic signal data of pecking from woodpeckers on the pole or nearby wooden pieces;
and optionally
an acoustic transducer arranged in the housing and configured to generate one or more audible sound waves, said acoustic transducer being in operative connection with a sensor surface of the housing such to induce a generated audible sound wave into the pole attached thereto, and
an acoustic receiver arranged in the housing and in operative connection with the sensor surface, said acoustic receiver configured to detect sound signals, wherein the sound signals comprise portions of the induced sound waves reflected at interfaces of the pole; and/or
an evaluation unit arranged in the housing and coupled to the acoustic sensor and acoustic deterrent and optionally the acoustic transducer, the evaluation unit configured to provide information about
a detected event acting on the power line in response to the detected temporal and relative change; and/or
a potential detection of a woodpecker in the vicinity;
a communication interface arranged in the housing, which is connected to the evaluation unit and configured to wirelessly transmit the detected temporal and relative change corresponding to an event or said information by the evaluation unit to an evaluation station located outside the housing.

2. The test and protection device according to claim 1, wherein the test and protection device comprises an evaluation unit configured, by comprising means and/or software, to
determine the species of woodpeckers involved based comparing the registered acoustic signal data with patterns or signatures unique for each woodpecker species stored in a database in an internal or external memory of the test and protection device,
determine the type of activity of the involved woodpecker based comparing the registered acoustic signal data with patterns or signatures unique for each type of activity stored in the same or different database in the internal or external memory of the test and protection device,
based on the determined woodpecker species and type of activity, chose a targeted deterrent action from available deterrent actions stored in the same or separate database in the internal or external memory of the test and protection device,
controlling settings of the at least one acoustic deterrent emitter according to the chosen deterrent action to emit a targeted deterrent acoustic signal to deter the identified woodpecker species.

3. The test and protection device according to claim 1, wherein the at acoustic sensors are configured to register acoustic signal data of pecking that create vibrations propagating in the pole or associated parts.

4. The test and protection device according to claim 1, wherein the acoustic sensors and/or the evaluation unit is configured, by comprising means and/or software, to filter out soundwaves via the surrounding air that may disturb the acoustic sensor measurements or deteriorate determination of the woodpecker species and/or activity.

5. The test and protection device according to any claim 1, wherein the at least one acoustic deterrent emitter is arranged on or near the monitored structure and configured, by comprising at least one transducer or loudspeaker, emitting a deterrent signal in the form of natural sounds tailored to deter the identified woodpecker species from causing further activity.

6. The test and protection device according to claim 5, wherein the at least one acoustic deterrent emitter is activated based on the output of the separate machine learning module or control unit and is configured to be adjusted or disabled as needed.

7. The test and protection device according to any claim 1, wherein the sensor surface comprises a curvature configured to cling to the wood piece, and optionally comprises one of:
a flexible material
a material that is different of a material of the casing not being part of the sensor surface;
Wherein, optionally an emission surface of the acoustic transducer forms a portion of the sensor surface or is directly attached thereto; and/or
wherein optionally a detector surface of the acoustic receiver forms a portion of the sensor surface or is directly attached thereto.

8. The test and protection device according to claim 1, wherein the evaluation unit is configured:
periodically trigger the acoustic sensor to obtain environmental sounds; and/or
to periodically trigger the acoustic transducer to generate the one or more audible sound waves; and/or
trigger the acoustic transducer to generate the one or more audible sound waves in response to a command received by the communication interface;
trigger the acoustic transducer to generate a pocking sound resembling wood pecking of a woodpecker species, optionally in response to a detection of sound resembling a woodpecker generated sound.

9. The test and protection device according to claim 1, wherein the acoustic transducer is configured to generate a plurality of sound signals subsequently at different frequencies; and/or
generate a plurality of sound signals at different frequencies at once.

10. The test and protection device according to claim 1, wherein the evaluation unit is adapted to identify at least one of the following events:
a mechanical load isolated from the earth, in particular snow or ice on the power line;
corona discharges due to deterioration of the insulators;
a change in the length of the power line between two holding points of the power line, in particularly caused by temperature or a change in temperature;
a mechanical resonance in the power line, particularly induced by wind;
an at least partially conductive connection, in particular in the form of vegetation close to the power line, which causes a corona or sporadic micro-shorts;
current flashovers or discharges to an at least partially conductive connection near the power line;
a short-circuit to earth, in particular due to vegetation coming into contact with the power line;
a phase short to an adjacent power line;
a lightning strike to the power line or to an element connected to the power line, in particular a pole
the presence of a woodpecker on the pole or in the vicinity
a degradation of the pole caused by at least one of ruptures, cuts, notches or indentation, rot, wood pecking; and fungal infestation.

11. The test and protection device according to wherein the detection unit comprises an amplifier and an analog-to-digital converter connected thereto with at least one digital filter connected downstream, the digital filter having one of the following types and/or functions:
finite impulse response, FIR;
averaging filter or moving average filter;
infinite impulse response, IIR;
Fast Fourier Transform filter, FFT;
Notch filter;
bandpass filter; or
low-pass or high-pass filter.

12. The test and protection device according to claim 1, wherein the antenna element comprises one of a flat shape, an elongated shape, and a spiral shape and is arranged below the power line, in particular at a distance of at least 1 meter.

13. The test and protection device according to claim 1, further comprising:
an energy storage, which is connected to the detection unit, the evaluation unit and the communication interface for supplying those;
optionally, a solar panel attached to the housing for charging the energy storage device.

14. The test and protection device according to claim 1, further comprising:
an accelerometer for detecting a mechanical event that triggers movement of the housing above a threshold acceleration or threshold velocity.

15. The test and protection device according to claim 1, wherein the communication interface is arranged to communicate information derived from the sound signals detected by the acoustic receiver and/or the acoustic sensor to an evaluation system located outside the housing.

16. The test and protection device according to claim 1, which
is further arranged to activate the detection unit at predetermined times; and/or
is further arranged to trigger the acoustic transducer periodically to generate the one or more audible acoustic waves; and/or
is further adapted to activate the detection unit and/or the acoustic transducer in response to a command received from the communication interface; and/or
is further adapted to periodically record sound signals using the acoustic sensor; and/or
is further adapted to activate at least one acoustic deterrent emitter in response to a command received from the communication interface.

17. An evaluation system for evaluating events on a power line, including an overhead power line, comprising:
at least one test and protection device according to claim 1, each test and protection device attached to a respective pole of the power line;
an evaluation station configured to communicate, wirelessly, with the test and protection device, and further configured to identify the event using a trained deep-learning model to which the detected temporal and relative change or the information about the detected event is applied.

18. The evaluation system of claim 17, wherein the evaluation station is configured to
locate, using a trained machine learning model, at least a position and a severity of possible damage to the pole based on information derived from the acoustic signals detected by the acoustic receiver
classify the datasets by assistive learning of acoustic signal data from at least one acoustic sensor to identify the improve the labelling/classification of the type of activity performed by the woodpecker and optionally if it is causing damage to the pole or associated parts, and/or noise,
determine the type of pecking activity of the involved woodpecker species based on stored patterns or signatures unique for each activity,
determine the woodpecker species involved based on stored patterns or signatures unique for each woodpecker species, and/or

19. The evaluation system according to claim 17, wherein the evaluation station is configured to identify at least one of the following events:
a mechanical load isolated from the earth, in particular snow or ice on the power line;
corona discharges due to deterioration of the insulators;
a change in the length of the power line between two holding points of the power line, in particularly caused by temperature or a change in temperature;
a mechanical resonance in the power line, particularly induced by wind;
an at least partially conductive connection, in particular in the form of vegetation close to the power line, which causes a corona or sporadic micro-shorts;
current flashovers or discharges to an at least partially conductive connection near the power line;
a short-circuit to earth, in particular due to vegetation coming into contact with the power line;
a phase short to an adjacent power line;
a lightning strike to the power line or to an element connected to the power line, in particular a pole; and
a deterioration of the pole to which the test and protection device is attached, in particular by one of fractures, cuts, notches or depressions, indentations, rot and fungal infestation.

20. The evaluation system according to claim 17, wherein the evaluation unit is configured to receive at least one of the types of wood piece, a shape based on a list of role model shapes, its a geometry, and a position of the test and protection device on the wood piece as input, for the trained deep-learning model.
